(19) United States
(12) Patent Application Publication
(10) Pub. No.: US 2019/0335796 A1
(43) Pub. Date: Nov. 7, 2019

(54) OPTIMIZED NUTRIENT FOOD

(71) Applicants: JOLLY MATHEW VADAKKEMURI, ERNAKULAM (IN); THOMSON PAUL KOCHERY, ERNAKULAM (IN); PAULOSE THOMSON KOCHERRY, ERNAKULAM (IN)

(72) Inventors: JOLLY MATHEW VADAKKEMURI, ERNAKULAM (IN); THOMSON PAUL KOCHERY, ERNAKULAM (IN); PAULOSE THOMSON KOCHERRY, ERNAKULAM (IN)

(21) Appl. No.: 15/530,866

(22) PCT Filed: Aug. 31, 2015
(86) PCT No.: PCT/IN2015/000339

§ 371 Date: Mar. 10, 2017

(30) Foreign Application Priority Data
Sep. 1, 2014 (IN) 4248/CHE2014

(51) Int. Cl. A23L 33/12; A23L 33/21; A23L 33/125; A23L 33/155; A23L 33/16; A23L 33/175; A23L 33/00

(52) U.S. Cl. CPC A23L 33/12; A23L 33/21; A23L 33/125; A23V 2002/00; A23L 33/16; A23L 33/175; A23L 33/40; A23L 33/155

(57) ABSTRACT

An optimized nutrient food for optimization of bodily functions and thereby maintenance of health, prevention of diseases and delaying aging. The optimized nutrient food includes about 28% to about 36% of protein, about, 17% to about 26% of dietary fiber, about 6% to about 10% of omega 3 fatty acid, about 6% to about 10% of omega 6 fatty acid, about 4% to about 8% of omega 9 fatty acid, about 2% to about 6% of saturated fat, about 4% to about 13% of starch/sugar, about 6% to about 10% of vitamins and minerals, about 2% to about 5%, by weight of water and, a ratio of omega 3 fatty acid to omega 6 fatty acid ranging from about 0.75:1.25 to about 1.25:0.75. Methods of preparation of the optimized nutrient food as well as methods of treatment administering the optimized nutrient food.

### FIELD OF INVENTION

The disclosure generally relates to a low calorie optimized nutrient food having all the essential and nonessential nutrients in the correct proportion necessary for optimization of bodily functions and thereby maintenance of health, prevention of diseases and delay aging and the calorie is optimized to about 650. More specifically the optimized nutrient food includes high omega 3 fatty acid and omega 6 fatty acid in a ratio of 1:1; high dietary fiber content; high protein with complete amino acids and optimized with vitamins and minerals as per daily value recommendations of FDA, capable of providing about 650 calories per 150 gms, but without cholesterol, trans fat, preservative, coloring agent, and artificial flavoring agent.

### BACKGROUND

Globalization and industrialization has made sea of changes in the nature and availability of foods for human consumption. Global developmental and economic transitions brings the dual burden of poverty, malnourishment and infectious diseases at one end; diet and life style related degenerative diseases such as obesity, diabetes, hypertension, cardio vascular diseases and cancer at the other end.

Mechanization has reduced the need for a high calorie diet, but the need for other nutrients remains the same. Processed foods with high sodium and low potassium lead to hypertension and related diseases, both in the developed and developing nations of the world alike. Mechanized processing of food grain removes not only potassium but also most of the essential minerals, vitamins, fiber, essential fats and protein. Sedentary life style, lack of outdoor activities and dependence on motor vehicles makes the “Sunshine vitamin”, Vitamin D deficiency related issues a common problem even in tropical countries.

Added artificial coloring agents, preservatives, softening agents and flavoring agents give additional health hazards. Excess calories in diet and resultant obesity and its related health problem are challenging the developed countries and developing countries alike. Balancing calories and managing weight is the most important challenge for the individual and the nation. A good part of individual's and nation's economy is directed for managing obesity and diet related non communicable diseases (DRNCD) along with the loss of productivity due to illness.

Modern science and research has been able to throw light into the nutritional requirement of human beings, and the impact of deficiency as well as excess nutrients in our body. Imbalance in the form of excess or deficiency of nutrients can lead to physical, mental or behavioral abnormalities in humans which can lead to so called life style diseases or diet related non communicable diseases listing from congenital anomalies, behavioral abnormalities, intellectual performance reduction, heart disease, obesity, diabetes, hypertension, immunological problems, infection, psychiatric problem, cancer etc. A properly balanced, easy to consume, nutritional diet, is the solution for most of the modern diseases starting from congenital anomalies to cancer.

A number of patents are there in the field of nutritional food supplements for improving health and also to prevent malnourishment and infectious diseases.

WO 2012051591 A2 discloses nutritional compositions and formulations that optimize nutritional contents. Dietary compositions and methods for tailoring such compositions to optimize levels of nutrients that have beneficial effects within specific ranges are disclosed herein.

EP 0626177 B1 discloses generally to a liquid enteral nutritional product which has been formulated to address the nutritional needs of persons infected with human immunodeficiency virus (HIV), the use of the nutritional product and the benefits of using the nutritional product.

WO 2006058609 A1 pertains to a food product which incorporates polyunsaturated fatty acids and an encapsulated pro-oxidant, said food product having a water activity of 0.75 or less. The pro-oxidants may be metal salts such as copper, manganese, iron and/or zinc salts. Sources of omega-3 fatty acids include fish oil.

US20060280840 A1 pertains to Universal protein formulation meeting multiple dietary needs for optimal health and enhancing the human immune system. It includes a protein rich, dry dietary supplement comprising a blend of legume protein, whey protein, egg white, calcium caseinate and powdered skim milk that is specifically formulated for weight control without the use of artificial appetite suppressants.

US 20130261183 discloses nutritional compositions and formulations that optimize nutritional contents are provided. Dietary compositions and methods for tailoring such compositions to optimize levels of nutrients that have beneficial effects within specific ranges are provided.

US 20140065264 A1 discloses a nutritional composition is provided herein for optimizing fats, carbohydrates, and protein caloric ratios as it relates to balanced nutrition, general health, and muscle performance during exercise and for enhancing muscle cell repair and recovery following the cessation of exercise.

WO 2005096837 A2 provides a ready-to-use therapeutic food or nutritional supplement that includes a mixture of at least one ground, roasted cereal, and at least one ground, roasted legume or cooked leguminous protein extract, said at least one cereal and said at least one legume or leguminous protein extract being selected to be mutually complementary so as to provide a PDCAAS of at 5 least 60.

A review of other references reveals that though different approaches have been adopted for addressing the specific nutritional needs and as a food supplement for patients suffering from specific illness, there is no such optimal nutritious food which can be used as regular food and also as food supplement, meeting the statutory nutritional requirements prescribed by WHO and based on the recommendations of FDA. Hence there is need for holistic approach to address these deficiencies. Low calorie optimized nutrient food according to our disclosure is directed towards balancing calories to about 650 calories per 150 gms and obtaining optimal nutrition which are the two major challenges of human nutrition and diet related diseases of modern world.

Further the other references as well as manufactured and marketed food products available in the market are having one or other deficiencies. Supplements of micronutrients, vitamins, trace elements, calcium, iron, zinc etc. are available in the market either alone or in combinations; as tablets, capsules or syrup. Most of the vitamins and mineral supplements available in the market are having a high concentration of the said nutrient compared to the recommended daily allowance and contain only selected vitamins and minerals. The supplemented vitamins & minerals in higher than recommended allowances in a capsule/tablet will affect the absorption of nutrients in the product and also the nutrients which are normally present in the food. Excess amount of vitamins and minerals can adversely affect the intestinal function; and also if it is absorbed in to the circulation, over burden the excretory system and also it can produce diseases like hyper vitaminosis A, hyper vitaminosis D, Seleniosis etc.

Macro nutrient protein or amino acids, (as milk protein, whey protein, soya protein), alone or in combinations with other nutrients are available. Most of the protein food supplements are having very high protein concentration as whey protein or protein hydro lysate of 60-70%. The product with more than 34% protein is harmful for the normal functioning of the intestine. Omega 3 fatty acids are available in combination with other fatty acids as fish oil, flax seed oil, krill oil, squid oil, algae oil or combination of different oils. Supplementing omega 3 fatty acids as long chain omega 3 fatty acid EPA&DHA, will suppress the synthesis of EPA&DHA from ALA. The most common supplement of EPA and DHA are fish oil. There is a possibility of mercury poisoning and pesticide residue related health risk and disorders in blood clotting mechanism with over consumption of marine oils.

Artificial fiber supplements and refined fiber from natural sources are the ones usually available as fiber supplements. Dietary fiber is a source of phytonutrients. Our knowledge from medical & nutritional research regarding health benefits of phytonutrients are only in the preliminary stage. Artificially made or the refined type of fiber will be deficient in these protective phytonutrients, like isoflavones, lignin's and plant sterols etc. So, the fiber in the diet is to be considered as a source of the known and unknown phytonutrients and to be taken in the unrefined form.

Hence the present disclosure is directed towards giving an easy and simple solution for fast growing epidemic of obesity and diet related diseases of modern world like heart disease, hypertension, diabetes, arthritis, cancer etc.; by providing proteins with complete amino acid, dietary fiber with phytonutrients, essential omega 3&6 fatty acids in optimal quantity and concentration in 1:1 ratio, along with all micronutrients, 14 vitamins and 14 minerals as per the recommended daily allowance in 150 g unit of 650 Kcal. This food will give an easy solution for weight and nutrition management in the sedentary life style of the modern world with a holistic approach.

### OBJECTIVES

The main object of our objective is to provide food with all the essential nutrients in the correct proportion according to the recommended daily allowances necessary for optimization of bodily functions, maintenance of health, prevention of diseases and delay aging.

Another objective is to provide this minimal calorie nutrient rich food in a dry 150 g powder pack of about 650 calorie, easily preparable and palatable to the varied taste of the global population.

Another objective is to provide a balanced nutrient dense food product with all dietary essential nutrients in recommended daily allowance.

Yet another objective is to provide a product with low avoidable carbohydrate and saturated fat.

Another objective is to provide high omega 3 fatty acid with omega 3, 6 ratio 1:1 and omega 9 in moderate quantity.

One more object is to have a nutritional food with no cholesterol, no trans-fat, no preservative, no flavoring agents and no coloring agents.

### Need for Optimal Nutrition:

Using genetic blue prints inherited from its parents, a fetus begins to develop at the moment of conception, from the nutrients it absorbs. It requires certain nutrients to be present at certain times. These nutrients facilitate the chemical reactions that produce among other things, skin, bone, muscle etc. If there is a serious deficiency in one or more of these nutrients, a child may develop a deficiency disease ranging from congenital anomalies of heart to mental disorder in adulthood. Once the growth and development are completed, nutrients are needed for maintenance and repair of cells, tissues and organs that makeup the human body. If there is deficiency or excess of nutrient it can affect the basic functions of the body at cellular level. Hence intake of balanced diet with optimal nutrients is of paramount importance for a healthy person.

### SUMMARY

An optimized nutrient food for optimization of bodily functions and thereby maintenance of health, prevention of diseases and delaying aging is disclosed. The optimized nutrient food includes about 28% to about 36% of protein, about 17% to about 26% of dietary fiber, about 6% to about 10% of omega 3 fatty acid, about 6% to about 10% of omega 6 fatty acid, about 4% to about 8% of omega 9 fatty acid, about 2% to about 6% of saturated fat, about 4% to about 13% of starch/sugar, about 6% to about 10% of vitamins and minerals, about 2% to about 5%, by weight of water, and a ratio of omega 3 fatty acid to omega 6 fatty acid ranging from about 0.75:1.25 to about 1.25:0.75.

In some embodiments, the optimized nutrient includes a free essential amino acid to supplement the protein. Some embodiments of the optimized nutrient food provide about 466 calories. Some embodiments of the optimized nutrient food provide about 650 calories. In some embodiments of the optimized nutrient food the ratio of omega 3 fatty acid to omega 6 fatty acid is about 1:1. Some embodiments of the optimized nutrient food provide about 466 calories in 114 grams of the optimized nutrient food. Some embodiments of the optimized nutrient provide about 650 calories in about 150 grams of the optimized nutrient food. Some embodiments of the optimized nutrient food include about 33.5% of protein; about 24% of dietary fiber; about 8.5% of omega 3 fatty acids; about 8.5% of omega 6 fatty acids; a ratio of 1:1 of omega 3 fatty acid to omega 6 fatty acid; about 6% of omega 9 fatty acid; about 3% of saturated fat; about 4.5% of starch/sugar; about 8.3% of vitamins and minerals; and about 3.7% of water, by weight. Some embodiments further include added one or more free essential amino acids.

Some embodiments include a method of treatment of lifestyle and other disorders by administering the optimized nutrient food. The optimized nutrient food can be administered in low calories ranging from about 466 to about 650 calories, or in normal calories of about 2000 calories per day as per FDA, or in calories higher than 2000 calories per day.

Some embodiments provide a method of preparing an optimized nutrient food. The method includes selecting one or more component from a group consisting of a seed, a de-oiled seed, a nut, a de-oiled nut, a root, or combinations thereof, to obtain more than one selected component. Then the selected components are individually cleaned and made free from foreign matter/impurities and followed by washing with water and air drying. The cleaned components are individually or in combination heated at a temperature ranging from about 50 degrees centigrade to about 150 degrees centigrade for about 10 to about 60 minutes to obtain a denatured and dehydrated product. If the components were mixed prior then the mixed components are heated together. The denatured and dehydrated products are cooled individually or if the components are combined in previous steps then in combination. Cooling is performed at a temperature ranging from about 25 degrees centigrade to about 30 degrees centigrade. The cooled products are milled individually or in combination (if the components were previously combined) at a temperature ranging from about 30 degrees centigrade to about 40 degrees centigrade to obtain a particle size below 200 microns. Required quantities of the resultant individually milled powders are mixed (if the components were not previously combined). Any processed items intended to use are added at this stage for even mixing. Deficient nutrients are added. The deficient nutrients include vitamins, minerals, amino acid and combinations. The product is packed to minimize oxygen and sun light exposure and associated nutrient loss. In some embodiments, measuring the quantities of the individual components for preparing the nutrient food is performed at the same step where the components are selected. In some embodiments, a free amino acid is added to the mixture to meet the essential amino acid requirement.

Some embodiments provide a method of preparing an optimized nutrient food. The method includes selecting at least two seeds. To start with individually clean the selected seeds and made free from foreign matter/impurities and followed by washing with water and air drying. Then individually heat the cleaned seeds at a temperature ranging from about 50 degrees centigrade to about 150 degrees centigrade for about 10 to about 60 minutes to obtain denatured and dehydrated products of the cleaned seeds. Next cool the denatured and dehydrated products individually or in combination at a temperature ranging from about 25 degrees centigrade to about 30 degrees centigrade. The cooled products individually or in combination are subjected to milling at a temperature ranging from about 30 degrees centigrade to about 40 degrees centigrade to obtain a particle size ranging from about 50 microns to about 200 microns. Next, mix the required quantities of the resultant individually milled powders. Then adding deficient nutrients obtain the optimized nutrient food composition. The deficient nutrients are selected from a group consisting of vitamins, minerals, and combinations thereof. The resultant product is packed in such a way to minimize oxygen and sun light exposure and associated nutrient loss. In some embodiments of the method the seeds selected and required quantities are measured at the same step. In some embodiments, the method includes selecting an additional component such as a de-oiled seed, a nut, a de-oiled nut, a root, or combinations thereof to prepare the optimized nutrient food.

Some embodiments provide a method of preparing an optimized nutrient food. The method includes selecting one or more component such as a protein source, an omega 3 source, an omega 6 source, a fiber source, vitamins, and minerals to obtain more than one selected component. These selected unprocessed components are individually cleaned and heated at a temperature ranging from about 50 degrees centigrade to about 150 degrees centigrade for about 10 to about 60 minutes to obtain a denatured and dehydrated product. Resultant denatured and dehydrated products are cooled individually or in combination at a temperature ranging from about 25 degrees centigrade to about 30 degrees centigrade. Then it is milled individually or in combination at a temperature ranging from about 30 degrees centigrade to about 40 degrees centigrade to obtain a particle size ranging from about 50 microns to about 200 microns. If the resultant powders were milled individually, then, required quantities are mixed. Now add deficient nutrients to obtain the optimized nutrient food. Deficient nutrient maybe vitamins, minerals, or combinations thereof. Then, packing of the product is carried out with minimum oxygen exposure and associated nutrient loss. The resulting optimized nutrient food includes about 28% to about 36% of protein; about 17% to about 26% of dietary fiber; about 6% to about 10% of omega 3 fatty acid; about 6% to about 10% of omega 6 fatty acid; about 4% to about 8% of omega 9 fatty acid; about 2% to about 6% of saturated fat; about 4% to about 13% of starch/sugar; about 6% to about 10% of vitamins and minerals; about 2% to about 5%, by weight of water; and, a ratio of omega 3 fatty acid to omega 6 fatty acid ranging from about 0.75:1.25 to about 1.25:0.75.

Some embodiments provide a method of preparing an optimized nutrient food. The method includes selecting components such as a processed protein source, a processed omega 3 source, a processed omega 6 source, a processed fiber source, an artificially produced vitamin, and an artificially produced mineral. Then these selected components are mixed and packed with minimum oxygen exposure and associated nutrient loss. The selected components are in quantities required to provide the optimized nutrient food. The optimized nutrient food includes, about 28% to about 36% of protein; about 17% to about 26% of dietary fiber; about 6% to about 10% of omega 3 fatty acid; about 6% to about 10% of omega 6 fatty acid; about 4% to about 8% of omega 9 fatty acid; about 2% to about 6% of saturated fat; about 4% to about 13% of starch/sugar; about 6% to about 10% of vitamins and minerals; about 2% to about 5%, by weight of water; and, a ratio of omega 3 fatty acid to omega 6 fatty acid ranging from about 0.75:1.25 to about 1.25:0.75.

### BRIEF DESCRIPTION OF THE DRAWINGS/FIGURES

These objectives and other features, aspects, and advantages will become better understood when the following detailed description is read with reference to the accompanying drawings.

FIG. 1 shows 7 options of optimal food with varying calories from 466 to 3000 by adjusting Carbohydrates/Protein/Fats with Omega 3, 6 fatty acids in a ratio of 1:1.

FIG. 2 shows a flow diagram depicting the various stages in the method of manufacturing the optimal nutritious food.

### DETAILED DESCRIPTION

According to some embodiments provide a low calorie optimized nutrient food for optimization of bodily functions, maintenance of health, prevention of diseases and delay aging is having all essential and nonessential nutrients; high content of omega 3 and 6 fatty acid; with omega 3, 6 ratio of 1:1; high dietary fiber with phytonutrients; high protein with complete amino acids; optimized with vitamins and minerals as per daily value recommendations of FDA. Calorie is kept low by minimizing the saturated fat, starch and sugar. It is a no cholesterol, no trans-fat, no preservative, no coloring agent, and no artificial flavoring agent formulation. Unit of 150 g of dry powder with adequate water (2000 ml or above as per climatic condition) will give all nutrients needed for a day as per daily value; with calorie value of 650.

A low calorie optimized nutrient food according to our disclosure helps in optimization of bodily functions, maintenance of health, prevention of diseases and delay aging. It includes of a) protein with amino acids in the range of 28 to 36%; b) high dietary fiber in the range of 17 to 26%; c) omega 3 and 6 fatty acid each in the range of 6 to 10%; d) omega 9 fatty acid in the range of 4 to 8%; e) low content of saturated fat in the range of 2 to 6%; f) low content of starch/sugar in the range of 4 to 13%; g) vitamins and minerals in the range of 6 to 10% and h) water in the range of 2 to 5% wherein, the raw materials for the same is selected from food sources.

We also disclose here a method of preparing the state of the art optimized nutritious food from the following naturally occurring food sources in raw or processed form.
protein with complete amino acids is selected from the group of both seeds/deoiled seeds, nuts/deoiled nuts consisting of soya beans, goa beans, hemp seed, water melon seed, pumpkin seed, sesame seed, Bengal gram, green gram, pistachios, gingili seed, poppy seed, black gram, flax seed, ground nut, de-oiled ground nut, coconut, water melon seeds, and also milk protein, egg protein, animal protein, fish protein, protein from single cell organism, amino acids and combinations thereof.
omega 3 fatty acids are selected from the group consisting of flax seed, perilla seed, algae/algal oil, garden cress seed, mustard seed, chia seed, sacha inchi, hemp seed, walnut/oil, krill oil, squid oil, fish oil, clary sage seed/oil, and combinations thereof.
omega 6 are selected from the group consisting of gingili seed, sunflower seed, safflower seed, watermelon seed, corn seed, almond, cashew nut, black current seed, poppy seed, rape seed, borage seed/oil, evening primrose seed/oil, palm oil, avocado oil, olive oil, and combinations thereof.
high dietary fiber with phytonutrients are selected from the group consisting of oats bran, rice bran, fenugreek seed, soya beans, flax seed, garden cress seed, rice bran, chicory root, aniseed, sun root, perilla seed, safflower seed, inulin's, vegetable gums, fructose oligo saccharide, and combinations thereof.
Vitamins and minerals are optimized from Brazil nut for selenium; oats bran for chromium; gingili for zinc; garden cress and water melon seed for iron, artificial vitamins and minerals from appropriate salts, and combinations thereof.

The method of preparing the low calorie optimized nutrient food includes the steps of a) selecting the sources to obtain the expected composition; b) cleaning the selected seeds/nuts/roots required for the expected nutrient composition; c) heating the unprocessed raw material at 50-150 degree for 10 to 60 minutes for removing the water and denaturing the protein and polysaccharides, so as to destroy the trypsin inhibitors, microbes present in the raw material, and to improve shelf life, safety of the food and ensuring easy digestion and absorption of protein in the food; d) cooling the dehydrated and denatured raw material to normal temperature about 25 to 30 degree centigrade; e) subjecting to constant temperature milling at about 30 to 40 degree Centigrade to obtain a particle size of below 200 microns f) mixing required quantities of the resultant milled powder to obtain expected nutrient composition; g) addition of deficient nutrients if any like vitamins, minerals, essential fat, amino acids, protein and processed items to meet the expected composition; h) air expelled packing or nitrogen filling packing of the resultant product to minimize oxygen and sun light exposure and associated nutrient loss.

It is easy to prepare food stuffs, palatable to the varied taste and food habits of different cultures of the global population using this product. With this discovery it is possible to make vegan, vegetarian (ova lacto) or non-vegetarian food with all nutrients; as low as 650 calorie per day to high calorie of >4000 calorie according to the individual needs; high carbohydrate or high fat ketogenic diet according to the disease condition, example epilepsy; without affecting nutrient content and omega 3,6 ratio of 1:1.

Various food preparations can be prepared from the said low calorie optimized nutrient food. The Embodiments of the low calorie optimized nutrient food according to the present disclosure can prevent/treat obesity and diet related diseases including underweight, menstrual irregularity, reproductive problems, heart disease, hypertension, diabetes, arthritis, allergy, autoimmune diseases, inflammatory diseases, metabolic syndrome, degenerative diseases and cancer.

The purpose is to provide all nutrients with minimal calories (from carbohydrate and saturated fat). Hence, the findings of modern scientific research in the field of nutrition regarding different nutrients, and their optimal quantity required for the health and wellbeing of human beings has been taken into consideration. The present disclosed compositions are the result of the surprising finding attributed to synergetic effect of the constituents involved in the state of the art optimized nutrient food, that is an easy and simple solution for fast growing epidemic of obesity and diet related diseases of modern world like heart disease, hypertension, diabetes, arthritis, menstrual disorder, infertility, cancer etc. the effect of which on human beings is presented below.

According to the quantum of requirement, the nutrients are divided into two types; (1) Macro nutrients (2) Micro nutrients. According to the body's ability to synthesize, nutrients are divided into two types; (1) Essential nutrients (2) Non-essential nutrients.

Nutrients needed in large quantity are known as macro nutrients, which includes; (1) Carbohydrate (2) Fat (3) Protein. Nutrients needed in smaller quantities are known as micronutrients, which include 14 vitamins and 14 minerals. The nutrients which body cannot synthesis in sufficient quantity are known as essential nutrients, which include vitamins, minerals, essential fatty acids; omega 3-ALA and omega 6-LA and 9 essential amino acid viz. phenylalanine, valine, threonine, tryptophan, methionine, leucine, isoleucine, lysine, and histidine.

Different nutrients with its nature, functions, recommended dietary intake as daily value (DV) for 2000 calorie diet are given below. The DV is provided as per recommendations for a normal 2000 calorie diet for a person per day. The functions of the nutrients are also disclosed. The daily value of nutrients in this normal 2000 calorie diet defined by FDA was used as a basis to optimize the quantity of nutrients in the low calorie diet.

| Nutrient | DV | | Functions |
|---|---|---|---|
| Carbohydrate | 300 | g | Non essential carbohydrate are the body's main source |
| | | | of fuel. |
| Essential | | | Carbohydrates can be stored in the muscles |
| Dietary fiber | | | and liver as glycogen and later used for energy. |
| Non-essential | | | Dietary fiber act as bulking agent for stool |
| Starch, Sugar, | | | and prevent constipation, hemorrhoids and |
| Glycogen | | | colon cancer. |
| | | | Dietary fiber functions as prebiotic and aids |
| | | | the growth of intestinal microbes which |
| | | | ferment the indigestible fiber and produce |
| | | | short chain fatty acids, vitamin B12, |
| | | | vitamin K and Biotin. |
| Fat | <65 | g | Building block for cell membrane |
| Essential | | | Normal growth and development |
| Omega-3 fatty | | | Energy (fat is the most concentrated source of energy) |
| acid | | | |
| Omega-6 fatty | | | Absorbing certain vitamins (like vitamins |
| acid | | | A, D, E, K, and carotenoids) |
| Non-essential | | | Providing cushioning for the organs |
| Saturated fat | | | Maintaining cell membranes |
| Omega 9 fatty | | | Providing taste, consistency, and stability to foods |
| acid | | | |
| Cholesterol | | | |
| Trans fat | | | |
| Protein | 50 | g | Growth (especially important for children, |
| Essential | | | teens, and pregnant women) |
| 9 amino acids | | | Tissue repair |
| Semi essential | | | Immune function |
| 3 amino acids | | | Making essential hormones and enzymes |
| | | | Energy when carbohydrate is not available |
| Non-essential | | | Preserving lean muscle mass |
| 8 amino acids | | | |
| Vitamins | DV | | Functions |
| Vitamin A | 5000 | IU | Needed for vision, healthy skin and mucous membranes, |
| Retinol and its | | | bone and tooth growth, immune system health |
| precursor | | | |
| carotene | | | |
| Vitamin C | 60 | mg | Antioxidant; part of an enzyme needed for |
| Ascorbic acid | | | protein metabolism; important for immune |
| | | | system health; aids in iron absorption |
| Vitamin D | 400 | IU | Needed for proper absorption and utilization |
| | | | of calcium and phosphorus |
| Vitamin E | 30 | IU | Antioxidant; protects cell walls |
| Vitamin K | 80 | mcg | Needed for proper blood clotting |
| Vitamin B1 | 1.5 | mg | Part of an enzyme needed for energy |
| Thiamine | | | metabolism; important to nerve function |
| Vitamin B2 | 1.7 | mg | Part of an enzyme needed for energy |
| Riboflavin | | | metabolism; important for normal vision and |
| | | | skin health |
| Vitamin B3 | 20 | mg | Part of an enzyme needed for energy |
| Niacin | | | metabolism; important for nervous system, |
| | | | digestive system, and skin health |
| Vitamin B5 | 10 | mg | Part of an enzyme needed for energy metabolism |
| Pantothenic | | | |
| acid | | | |
| Vitamin B6 | 2 | mg | Part of an enzyme needed for protein |
| Pyridoxine | | | metabolism; helps make red blood cells |
| Vitamin B9 | 400 | mcg | Part of an enzyme needed for making DNA |
| Folic acid | | | and new cells, especially red blood cells |
| Vitamin B12 | 6 | mcg | Part of an enzyme needed for making new |
| Cobalamin | | | cells; important to nerve function |
| Biotin | 300 | mcg | Part of an enzyme needed for energy |
| | | | metabolism |
| Choline (Al) | 550 | mg | Synthesis of cell membrane and |
| | | | neurotransmitter acetylcholine. Act as |
| | | | methyl group donor. |
| Minerals | DV | | Functions |
| Potassium | 3500 | mg | A systemic electrolyte and is essential in coregulating |
| | | | ATPase activity with sodium. |
| Sodium | <2400 | mg | A systemic electrolyte and is essential in coregulating |
| | | | ATPase activity with potassium. |
| Calcium | 1000 | mg | Needed for muscle, heart and digestive |
| | | | system heath, builds bone, and supports |
| | | | synthesis and function of blood cells. |
| Phosphorous | 1000 | mg | A component of bones, cells, in energy |
| | | | processing and many other functions. |
| Magnesium | 400 | mg | Required for processing ATP and for bones. |
| Iron | 18 | mg | Required for many proteins and enzymes, |
| | | | notably hemoglobin to prevent anemia. |
| Zinc | 15 | mg | Pervasive and required for several enzymes |
| | | | such as carboxypeptidase, liver alcohol |
| | | | dehydrogenase, and carbonic anhydrase. |
| Manganese | 2 | mg | A cofactor in enzyme functions. |
| Copper | 2 | mg | Required component of many redox enzymes, |
| | | | including cytochrome c oxidase. |
| Chromium | 120 | mcg | Required for the action of insulin and act as |
| | | | glucose tolerance factor. |
| Molybdenum | 75 | mcg | Required for oxidases; xanthine oxidase, |
| | | | aldehyde oxidase, and sulfite oxidase. |
| Selenium | 70 | mcg | Cofactor essential to activity of antioxidant |
| | | | enzymes like glutathione peroxidase. |
| Chloride | 3400 | mcg | Needed for production of hydrochloric acid |
| | | | in the stomach and in cellular pump |
| | | | functions. |
| Iodine | 150 | mcg | Required not only for the synthesis of |

thyroid hormones, and to prevent goiter,
but also probably as an antioxidant, for extra
thyroidal organs as mammary and
salivary glands and for gastric mucosa
and immune system (thymus):

Taking into consideration of the above requirements, with a view to find an easy solution for diet related modern health problems, some embodiments provide a low calorie (about 466 to about 650 calories) optimized nutrient food by including unprocessed and/or processed food sources to obtain a) protein with amino acids in the range of about 28 to about 36%; b) high content of dietary fiber in the range of about 17 to about 26%; c) omega 3 and 6 fatty acid each in the range of about 6 to about 10% and in a ratio of omega 3 to omega 6 fatty acid ranging from about 0.75:1.25 to about 1.25:0.75; d) omega 9 fatty acid in the range of and 4% to about 8%; e) low content of saturated fat in the range of about 2% to about 6%; f) low content of starch/sugar in the range of about 4% to about 13%; g) vitamins and minerals in the range of about 6% to about 10% and h) water in the range of about 2% to about 5%. Another feature of the optimized nutritious food disclosed here is that it is free of cholesterol, trans-fat, artificial coloring agents, preservative, or flavoring agents.

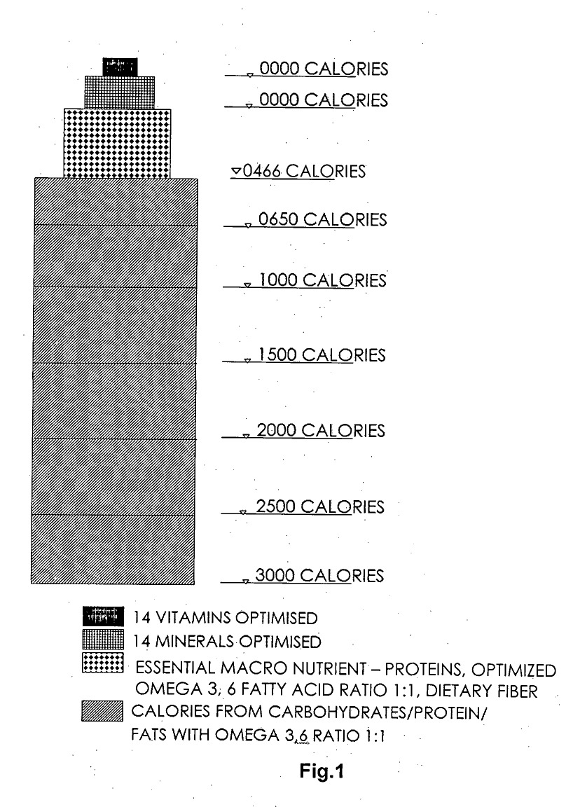

A low calorie food ranges in calories as low as about 466 as shown in FIG. 1. This much calorie comes from essential nutrients such as protein, fibre and essential fat (omega 3 and omega 6 fatty acids), with no calories from vitamins and minerals. The recommended dietary allowance (RDA) for calorie as per FDA food label is about 2000 cal, which is considered as the normal average calorie needs range. Food providing higher than 2000 calories is considered high calorie. In the disclosed embodiments, optimized means even though calorie value is low by reducing saturated fat, starch and sugar all the other nutrients protein with all essential and non essential amino acids+essential and non essential fat+essential carbohydrate+14 vitamins+14 minerals are in amount required for daily value as per RDA, but the total calorie is only 650 instead of 2000 in standard referral diet. Some treatment methods such as for weight loss and for sedentary and obese populations needs the disclosed embodiments of the low calorie optimized nutrient food. The essential nutrients, all the vitamins, all the minerals, protein, dietary fiber, essential fats such as omega 3 and omega 6 contains about 466 calories. Even though the non-essential nutrients can be synthesized by the body, some non-essential fat and starch/sugar are incorporated to avoid the strain on the body of making them. This brings up the calorie content of the optimized nutrient food to about 650 calories per day. Therefore the disclosed low calorie embodiments of the optimized nutrient food achieve a low calorie diet that provides all the essential and non-essential nutrient, at the same time maintaining a total low calorie intake per day by means of decreasing the non-essential carbohydrate and non-essential fat in the food. The ratio of omega 3 to omega 6 fatty acid ranges from 0.75:1.25 to about 1.25:0.75 in some embodiments. The ratio of omega 3 to omega 6 fatty acid is about 1:1 in some embodiments.

In some embodiments, low calorie food ranging from about 466 to about 650 calories could be converted to a normal or high calorie diet by adding additional carbohydrate, protein or fat as shown in FIG. 1.

The sources used for high protein with complete amino acids are:—soya beans, water melon seed, flax seed, ground nut, de-oiled coconut etc. for vegan (no milk, egg) food, and may add milk/egg protein in vegetarian food and animal protein in non-vegetarian food. The source for omega3 fatty acids are:—flax seed, perilla seed, algae/algal oil, garden cress seed etc. for vegan food. For non-vegetarian food fish/oil also can be added. The source for omega 6 include gingili seed, sunflower seed, safflower seed, watermelon seed etc. The source used for high dietary fiber with phytonutrients are: oats bran, fenugreek seed, soya beans, flax seed, garden cress seed, rice bran etc. Optimization of vitamins and minerals done by using natural sources like Brazil nut for selenium, oats bran for chromium, gingili for zinc, garden cress and water melon seed for iron or by adding vitamins and minerals during preparation.

All these materials are not necessary to arrive to the expected nutrient formulation. It is possible to compound it with few items according to the seasonal availability. Some of such combinations of natural source used as the input material in the process of manufacture according to certain exemplary embodiments are given below.

| | | | | | |
|---|---|---|---|---|---|
| 1 | Sunflower | De oiled | Linseed | Walnut | Brazil nut |
| | seeds | watermelon | | | |
| | | seed | | | |
| 2 | Soybeans | PeriIla seeds | De oiled | Garden | Brazil nut |
| | | | ground nut | cress seeds | |
| 3 | Goa Beans | Chia seeds | Water melon | Gingili seed | Fenugreek |
| | | | seeds | | |
| 4 | Hemp | Cashew nut | Sacha inchi | Chicory | Fenugreek |
| | seed | | | root | |
| 5 | Ground nut | Flax seed | Hazel nut | Sun root | Whey |
| | | | | | protein |

However the quantity required will be assessed based on the raw material source/nutritional value so as to obtain about 650 calorie per 150 gms of the optimized nutrient food having the desired composition disclosed above. Further it will be optimized with nutrients.

According to another embodiment under the invention, is found that, the optimized nutrient food can give optimal nourishment for the developing ovum and sperm resulting in better fertility. Further it gives balanced nourishment for pregnant mother and product of conception, the placenta and fetus; thereby ensuring health of pregnant mother and optimal growth and development of the baby in utero.

Some embodiments provide high omega 3 with omega 3, 6 fatty acid ratio of 1:1 which was the proportion for the hunter gatherer population's diet (Paleolithic diet). This proportion had a decisive role in the evolution of the human race and it's genetic pattern. Proper function of our inflammatory system depends on the presence of messaging molecules called eicosanoids. Group of eicosanoids made from ecosapentanoicacid (EPA) are anti-inflammatory in effect. EPA is made from omega3 ALA. Another group of eicosanoidsmade from Arachidonic acid (AA) which is pro inflammatory in effect and is made from omega 6 fat LA. So it is essential to equalize LA & ALA to make equilibrium for AA & EPA to balance inflammatory and anti-inflammatory activities at cellular level.

Proper function of nerve system, including the brain, depends on the presence of DocosaHexanoic Acid (DHA), an omega 3 fatty acid made from ALA and Arachidonic acid (AA) made from LA an omega 6 fatty acid. DHA accounts for 9-12% of our brains' total weight. Drop in DHA levels are known to associate with cognitive impairment or slower neurological development in children. The enzyme needed for conversion of LA to Arachidonic acid (AA) and ALA to EPA & DHA are the same. When LA is in excess compared to ALA the conversion of ALA to EPA & DHA will be reduced due to the competition for the same enzyme by both the substrates. For effective conversion of ALA to EPA&DHA, omega 3&6 fatty acids to be in almost equal proportion and also certain other nutrients like vitamin B3, vitamin B6, vitamin C, zinc, magnesium and selenium should be available in optimal quantity. To keep the balance of cardiovascular, nervous, immune, hormonal, and inflammatory system, it is essential to have equilibrium of omega 3&6 fatty acids along with other vitamins and minerals in optimal concentration.

Some embodiments also provide high potassium and low sodium. Evolutionally humans have evolved with a diet of low sodium or no added salt diet. On land which may be considered to be sodium restricted environment, powerful inbuilt mechanisms are there in the body to conserve sodium. The minimum requirement of sodium for a healthy adult person is 500 mg/day. Evolutionally potassium in the diet is high, humans have no inbuilt mechanism to conserve potassium, unlike sodium. The processed foods in general have their potassium removed during processing and is replaced by sodium. A number of studies in humans suggest a primary role of low dietary potassium and high sodium in the pathogenesis of hypertension. This food gives high potassium according to daily value and low sodium as recommended in DASH diet. Another feature of this food is, it tallies with the recommended diet for the renal stone patients i.e. low animal protein, low sodium, high potassium and added calcium with plant food to prevent oxalic acid absorption and formation of oxalate crystals in the urinary tract.

According to an exemplary embodiment a ‘650 calorie optimized nutrient food’ includes about 33.5% protein 33.5% with a complete amino acid score, a high dietary fiber of about 24%, a high omega 3 fatty acid of about 8.5%, omega 6 fatty acid of about 8.5%, omega 9 fatty acid of about 6%, low content of saturated fat of about 3%, low content of starch/sugar of about 4.5%, vitamins and minerals of about 8.3% and water of about 3.7%, while maintaining a ratio of omega 3 fatty acid to omega 6 fatty acid 1:1. There is no cholesterol, no trans-fat, no artificial coloring agents, no preservative, or no flavoring agents in the composition of this novel nutritious food.

An optimized nutrient food for optimization of bodily functions and thereby maintenance of health, prevention of diseases and delaying aging is disclosed. The optimized nutrient food includes about 28% to about 36% of protein, about 17% to about 26% of dietary fiber, about 6% to about 10% of omega 3 fatty acid, about 6% to about 10% of omega 6 fatty acid, about 4% to about 8% of omega 9 fatty acid, about 2% to about 6% of saturated fat, about 4% to about 13% of starch/sugar, about 6% to about 10% of vitamins and minerals, about 2% to about 5%, by weight of water, and a ratio of omega 3 fatty acid to omega 6 fatty acid ranging from about 0.75:1.25 to about 1.25:0.75.

In some embodiments, the optimized nutrient includes a free essential amino acid to supplement the protein. Some embodiments of the optimized nutrient food provide about 466 calories whereas according to another embodiment of the optimized nutrient food provide about 650 calories. In some embodiments of the optimized nutrient food the ratio of omega 3 fatty acid to omega 6 fatty acid is about 1:1. Some embodiments of the optimized nutrient food provide about 466 calories in 114 grams of the optimized nutrient food. Some embodiments of the optimized nutrient provide about 650 calories in about 150 grams of the optimized nutrient food. Some embodiments of the optimized nutrient food include about 33.5% of protein; about 24% of dietary fiber; about 8.5% of omega 3 fatty acids; about 8.5% of omega 6 fatty acids; a ratio of 1:1 of omega 3 fatty acid to omega 6 fatty acid; about 6% of omega 9 fatty acid; about 3% of saturated fat; about 4.5% of starch/sugar; about 8.3% of vitamins and minerals; and, about 3.7% of water, by weight. Some embodiments further include one or more free essential amino acids.

In some embodiments of the optimized nutrient food a free essential amino acid is added. The optimized nutrient food is free of cholesterol, trans-fat, or preservatives. A total calorie value of about 650 calories is obtained from about 150 gms of the optimized nutrient food. The optimized nutrient food provides the recommended daily allowance of nutrients such as dietary fibre, essential fat, and protein with complete amino acids, vitamins, macro minerals and trace elements. A source for preparing the optimized nutrient food can be natural source, except for vitamins, minerals and essential amino acids that are additionally included for optimization of the nutrients in the optimized nutrient food. A source for the protein with complete amino acids can be soya beans, goa beans, hemp seed, water melon seed, pumpkin seed, sesame seed, Bengal gram, green gram, pistachios, gingili seed, poppy seed, black gram, flax seed, ground nut, de-oiled ground nut, de-oiled coconut, de-oiled water melon seeds, milk protein, egg protein, animal protein, protein from single cell organism, amino acid, any other suitable source of protein or combinations thereof. A source for the omega 3 fatty acids can be flax seed, perilla seed, algae/algal oil, garden cress seed, mustard seed, chia seed, sacha inchi, hemp seed, walnut, krill oil, squid oil, fish oil, clary sage seed oil, any other suitable source of omega 3 fat, or combinations thereof. A source for the omega 6 fatty acids can be gingili seed, sunflower seed, safflower seed, watermelon seed, corn seed, almond, cashew nut, black current seed, poppy seed, rape seed, borage seed oil, evening primrose oil, palm oil, avocado oil, olive oil, any other suitable source of omega 6 fat, or combinations thereof. A source for the high dietary fiber can be oats bran, fenugreek seed, soya beans, flax seed, garden cress seed, rice bran, chicory root, aniseed, sunroot, perilla seed, safflower seed, and any other suitable source of dietary fibre or combinations thereof. The optimization of vitamins and minerals can be performed by including sources such as Brazil nut for selenium; oats bran for chromium; gingili for zinc; garden cress and water melon seed for iron, artificial vitamins and minerals from suitable salts, or combinations thereof. Additional carbohydrate can be added, or additional protein can be added, or additional fat having a 1:1 ratio of omega 3 to omega 6 can be added, to prepare a balanced nutrition food having calories greater than 650 calories. Optimized nutrient food providing greater than 4000 calories can also be prepared.

The optimized nutrient food can be used to treat conditions including obesity, an underweight patient, menstrual irregularity and reproductive problems, heart disease, hypertension, diabetes, metabolic syndrome, fatty liver and liver diseases, arthritis allergies, inflammatory disorders, asthma, cancer, improving fertility, providing balanced nourishment to a pregnant mother, or a product of conception, or a placenta, or a fetus, optimizing growth and development of a baby in utero, ensuring health of a pregnant person, optimizing growth and development of a breast feeding baby by administering the optimized nutrient food to a breast feeding mother, optimizing growth and development of children, giving DASH diet (Dietary Approaches to Stop Hypertension), giving diet for reducing occurrence of renal stone, optimizing health and performance of athletes and sports persons, defense personals, astronauts, mariners and persons working under restricted conditions, optimizing health of adults and delaying aging, optimizing health and improving quality of life of a senior citizen, optimizing the health and quality of life of a mentally challenged person, optimizing recovery and health of a sick and recuperating patient etc.

Some embodiments provide a method of preparation of a low calorie optimized nutrient food. Some embodiments provide a method of preparation of a normal calorie optimized nutrient food. Some embodiments provide a method of preparing a high calorie optimized nutrient food.

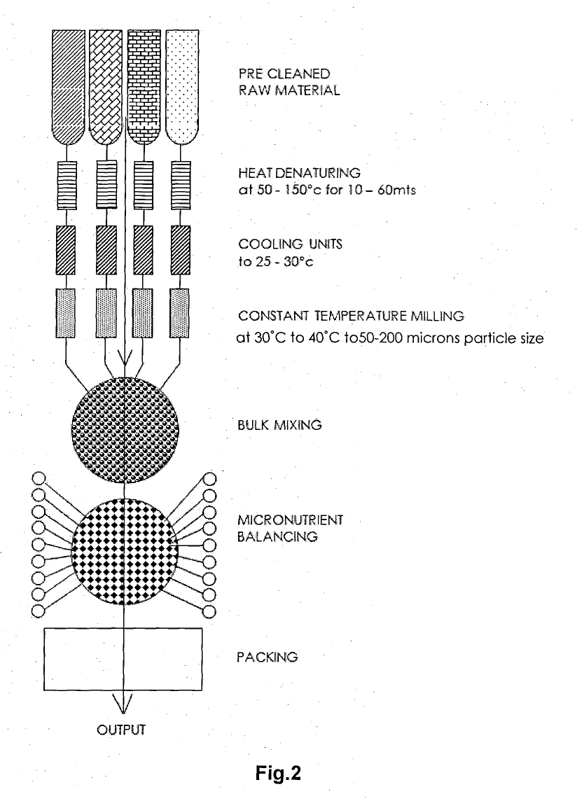

Referring to FIG. 2, selected input raw material like seeds/nuts/roots required for the expected nutrient composition, are pre cleaned individually. Then it is heated at 50-150 degree centigrade for 10 to 60 minutes for removing the water and denaturing the protein and polysaccharides. This will help to destroy the trypsin inhibitors and ensuring easy digestion and absorption of protein in the food. Heat denaturation of the protein will reduce the chance of food allergy. Heat denaturation will also help to destroy the microbes present in the raw material and help to improve shelf life and safety of the food. After dehydration and denaturation the seeds are cooled to normal temperature about 25 to 30 degree centigrade. Then it is subjected to constant temperature milling at about 30 to 40 degree centigrade to obtain a particle size of 50 to 200 microns. After milling it is mixed in required quantities to obtain expected nutrient composition. At this stage deficient nutrients if any like vitamins, minerals, essential fat, amino acid, processed items etc. are added to meet the expected composition. Further it is packed. Air expelled packing or nitrogen filling packing is followed to minimize oxygen and sun light exposure and associated nutrient loss.

Some embodiments provide a further modified method of preparing an optimized nutrient food. The method includes selecting one or more component from a group consisting of a seed, a de-oiled seed, a nut, a de-oiled nut, a root, or combinations thereof, to obtain more than one selected component. Then the selected components are individually cleaned or cleaned after mixing required quantities of the components. The cleaned components are individually heated at a temperature ranging from about 50 degrees centigrade to about 150 degrees centigrade for about 10 to about 60 minutes to obtain a denatured and dehydrated product. If the components were mixed prior to cleaning, then the mixed components are heated together. The denatured and dehydrated products are cooled individually or if the components are combined in previous steps then in combination. Cooling is performed at a temperature ranging from about 25 degrees centigrade to about 30 degrees centigrade. The cooled products are milled individually or in combination (if the components were previously combined) at a temperature ranging from about 30 degrees centigrade to about 40 degrees centigrade to obtain a particle size ranging from about 50 microns to about 200 microns. Required quantities of the resultant individually milled powders are mixed (if the components were not previously combined). Deficient nutrients are added. The deficient nutrients include vitamins, minerals, amino acids, and combinations. The product is packed to minimize oxygen exposure and associated nutrient loss. In some embodiments, measuring the quantities of the individual components for preparing the optimized nutrient food is performed at the same step where the components are selected. In some embodiments, a free amino acid is added to the mixture to meet the essential amino acid requirement.

In yet another embodiment provides a method of preparing an optimized nutrient food in a still slightly different manner. Here the method includes selecting at least two seeds. Individually the selected seeds are cleaned. Then individually they are heated at a temperature ranging from about 50 degrees centigrade to about 150 degrees centigrade for about 10 to about 60 minutes to obtain denatured and dehydrated products of the cleaned seeds. Next, the denatured and dehydrated products individually or in combination cooled at a temperature ranging from about 25 degrees centigrade to about 30 degrees centigrade. Then it is milled individually or in combination at a temperature ranging from about 30 degrees centigrade to about 40 degrees centigrade to obtain a particle size ranging from about 50 microns to about 200 microns. Next, mixing required quantities of the resultant individually milled powders. Then adding deficient nutrients obtain the optimized nutrient food composition. The deficient nutrients are selected from a group consisting of vitamins, minerals, and combinations thereof. Then packing the product is packed in such a way to minimize oxygen exposure and associated nutrient loss. In some embodiments of the method the seeds selected and required quantities are measured at the same step. In some embodiments, the method includes selecting an additional component such as a de-oiled seed, a nut, a de-oiled nut, a root, or combinations thereof to prepare the optimized nutrient food.

According to yet another embodiment, method of preparing an optimized nutrient food includes selecting one or more component such as a protein source, an omega 3 source, an omega 6 source, a fiber source, a vitamin source, a mineral source to obtain more than one selected component. Then selected components are individually cleaned. Next, the cleaned components are heated individually at a temperature ranging from about 50 degrees centigrade to about 150 degrees centigrade for about 10 to about 60 minutes to obtain a denatured and dehydrated product. Resultant denatured and dehydrated products are cooled individually or in combination at a temperature ranging from about 25 degrees centigrade to about 30 degrees centigrade. Then, milling the products individually or in combination at a temperature ranging from about 30 degrees centigrade to about 40 degrees centigrade to obtain a particle size ranging from about 50 microns to about 200 microns is the next step in the process. Now if the resultant powders were milled individually, then, mixing the required quantities has to be carried out. Then, add deficient nutrients to obtain the optimized nutrient food. Deficient nutrient maybe vitamins, minerals, or combinations thereof. Then, packing the product has to be carried out in a manner to minimize oxygen exposure and associated nutrient loss. The resulting optimized nutrient food includes about 28% to about 36% of protein; about 17% to about 26% of dietary fiber; about 6% to about 10% of omega 3 fatty acid; about 6% to about 10% of omega 6 fatty acid; about 4% to about 8% of omega 9 fatty acid; about 2% to about 6% of saturated fat; about 4% to about 13% of low starch/sugar; about 6% to about 10% of vitamins and minerals; about 2% to about 5%, by weight of water; and, a ratio of omega 3 fatty acid to omega 6 fatty acid ranging from about 0.75:1.25 to about 1.25:0.75.

In another embodiment the method of preparing an optimized nutrient food includes selecting components such as a processed protein source, a processed omega 3 source, a processed omega 6 source, a processed fiber source, an artificially produced vitamin, and an artificially produced mineral. Then mixing the selected components. Next packing the mixture to minimize oxygen exposure and associated nutrient loss. The selected components are in quantities required to provide the optimized nutrient food. The optimized nutrient food includes, about 28% to about 36% of protein; about 17% to about 26% of dietary fiber; about 6% to about 10% of omega 3 fatty acid; about 6% to about 10% of omega 6 fatty acid; about 4% to about 8% of omega 9 fatty acid; about 2% to about 6% of saturated fat; about 4% to about 13% of starch/sugar; about 6% to about 10% of vitamins and minerals; about 2% to about 5%, by weight of water; and, a ratio of omega 3 fatty acid to omega 6 fatty acid ranging from about 0.75:1.25 to about 1.25:0.75.

The free amino acid can be lysine, tryptophan, phenylalanine, tyrosine, methionine, cysteine, threonine, leucine, isoleucine, valine, arginine, histidine, or combinations thereof. The seed or de-oiled seed can be soya beans, goa beans, water melon seeds, flax seed, perilla seed, hemp seed, sacha inchi seed, sun flower seed, safflower seed, almond, garden cress seed, oats gingili seed, fenugreek, pumpkin seeds, pistachio, corn seed, rape seed, poppy seed, sesame seed, black gram, Bengal gram, green gram, any other suitable seed or combinations thereof. The nut or de-oiled nut can be walnut, ground nut, coconut, cashew nut, brazil nut, hazel nut, any other suitable nut or combinations thereof. The root can be chicory root, sun root, ginger root, arrow root, tapioca, potato, sugar beet, any other suitable root, or combinations thereof. The vitamins can be Vitamin A, Vitamin D, Vitamin E, Vitamin K, Vitamin C, B complex vitamins, biotin, choline, or combinations thereof. The minerals can be suitable salt forms of minerals. The minerals can be potassium, chloride, calcium, phosphorus, sodium, magnesium, zinc, iron, manganese, copper, iodine, chromium, molybdenum, selenium, or combinations thereof. Additional components can be algae, milk protein, whey protein, egg protein, fish protein, meat protein, algae oil, fish oil, krill oil, squid oil, evening primrose oil, black current seed oil, borage seed oil, clary sage oil, any other suitable source or combinations thereof. The unprocessed protein can be a seed or de-oiled seed. The unprocessed protein can be a nut or a de-oiled nut. The unprocessed source of fiber can be a seed, a nut, or root or combinations thereof. The processed protein source can be milk protein, whey protein, egg protein, fish protein, meat protein, and processed vegetable protein, protein from single cell organism or combinations thereof. The processed omega 3 source can be flax seed oil, perilla oil, walnut oil, sacha inchi seed oil, hemp seed oil, chia seed oil, echium oil, kiwifruit seed oil, canola oil, algae, algae oil, fish oil, krill oil, squid oil, clary sage oil, soybean oil and any other suitable source or combinations thereof. The processed omega 6 source can be evening primrose oil, black current seed oil, borage seed oil, hemp seed oil, sun flower oil, safflower oil, corn oil, cotton seed oil, gingili oil, ground nut oil, rice bran oil, soybean oil and any other suitable source or combinations thereof. The unprocessed omega 3 source can be flax seed, perilla seed, garden cress seed, mustard seed, canola seed, chia seed, sacha inchi, hemp seed, walnut, clary sage seed, any other suitable source of omega 3 fat, or combinations thereof. The unprocessed omega 6 source can be gingili seed, sunflower seed, safflower seed, watermelon seed, corn seed, almond, cashew nut, ground nut, pumpkin seed, hemp seed, black current seed, poppy seed, rape seed, borage seed, evening primrose, any other suitable source of omega 6 fat, or combinations thereof. The processed dietary fiber sources can be inulins, vegetable gums, fructose oligo saccharide, any other suitable source of processed dietary fiber, or combinations thereof.

In an exemplary embodiment, it is possible to have all essential nutrients in recommended quantities according to the latest scientific research, in an easy to prepare, palatable to the varied taste and food habits of different cultures of the world in a 150 gm dehydrated powder pack with a total calorie value of 650.

In an exemplary embodiment, calorie content and nutrient content per 150 g (approximate value) of the invented food along with daily value (DV) or adequate intake (AI) of nutrients as per international guide lines are given below for better understanding and comparison.

TABLE 1
Percentage of nutrients in the invented food with range

| | Percentage | |
|---|---|---|
| Nutrients | (approximate value) | Range |
| Total Carbohydrate | 28.5% | 26-35% |
| Dietary fiber | 24% | 17-26% |
| Sugar/Starch | 4.5% | 4-13% |
| Total fat | 26% | 24-28% |
| Saturated fat | 3% | 2-6% |
| Mono unsaturated fat | 6% | 4-8% |
| Omega 3 fat | 8.5% | 6-10% |
| Omega 6 fat | 8.5% | 6-10% |
| Cholesterol | 0 | 0 |
| Trans fat | 0 | 0 |
| Protein | 33.5% | 28-36% |
| Vitamins & Minerals | 8.3% | 6-10% |
| Water | 3.7% | 2-5% |
| Total | 100% | — |

TABLE 2
Nutrient content in 150 g with range of 125-175 g

| | Nutrients in 150 g | Nutrients in range |
|---|---|---|
| Nutrients | (approximate value) | in grams |
| Total Carbohydrate | 43 | 40-55 |
| Dietary fiber | 36 | 25-39 |
| Sugar/Starch | 7 | 6-18 |
| Total fat | 39 | 36-43 |
| Saturated fat | 4.5 | 3-9 |
| Mono unsaturated fat | 9 | 6-12 |
| Omega 3 fat | 12.75 | 9-16 |
| Omega 6 fat | 12.75 | 9-16 |
| Cholesterol | 0 | <300 |
| Trans fat | 0 | 0 |
| Protein | 50 | 42-54 |
| Vitamins & Minerals | 12.5 | 9-15 |
| Water | 5.5 | 3-8 |
| Total | 150 g | — |

TABLE 3
Energy in 150 grams of invented food with range

| | Daily | | Energy |
|---|---|---|---|
| | Value | Energy in 150 g in cal | range |
| Energy from | in cal | (approximate value) | in cal |
| Carbohydrate | 1200 | 100 | 75-125 |
| Fat | 600 | 350 | 262-438 |
| Protein | 200 | 200 | 150-250 |
| Total calories | 2000 | 650 | 487-780 |

TABLE 4
Macronutrients in 150 grams of invented food with range

| | Daily value | | |
|---|---|---|---|
| | or adequate | | Nutrients |
| | intake (AI) | Nutrients | range in |
| Macronutrients | in grams | in grams | grams |
| Carbohydrate | 300 | 43 | 40-55 |
| Dietary fiber | 25 | 36 | 25-39 |
| Sugar/Starch | 275 | 7 | 6-18 |
| Fat | <65 | 39 | 36-43 |
| Saturated fat | <20 | 4.5 | 3-9 |
| Mono unsaturated fat | — | 9 | 6-12 |
| Omega 3 fat (Al) | 1.6 | 12.75 | 9-16 |
| Omega 6 fat (Al) | 12 | 12.75 | 9-16 |
| Cholesterol | <300 mg | 0 | <300 mg |
| Trans fat | — | 0 | 0 |
| Protein | 50 | 50 | 42-54 |

TABLE 5
Micronutrients in 150 grams of invented food with range I and II

| | Daily value | | Nutrients | | | | |
|---|---|---|---|---|---|---|---|
| | or adequate | | (approximate | | Nutrients | Nutrients | |
| Vitamins | intake (AI) | | value) | | range I | range II | |
| Vitamin A | 5000 | IU | 5000 | IU | 3750-5000 | 3750-6250 | IU |
| Vitamin C | 60 | mg | 60 | mg | 45-60 | 45-75 | mg |
| Vitamin D | 400 | IU | 400 | IU | 300-400 | 750-1250 | IU |
| Vitamin E | 30 | IU | 30 | IU | 22-30 | 22-38 | IU |
| Vitamin K | 80 | mcg | 80 | mcg | 60-90 | 60-100 | mcg |
| Vitamin B1 | 1.5 | mg | 1.5 | mg | 1-1.5 | 1-2 | mg |
| Vitamin B2 | 1.7 | mg | 1.7 | mg | 1.2-1.7 | 1.2-2.1 | mg |
| Vitamin B3 | 20 | mg | 20 | mg | 15-20 | 15-25 | mg |
| Vitamin B5 | 10 | mg | 10 | mg | 7.5-10 | 7.5-12.5 | mg |
| Vitamin B6 | 2 | mg | 2 | mg | 1.5-2 | 1.5-2.5 | mg |
| Vitamin B9 | 400 | mcg | 400 | mcg | 300-400 | 300-500 | mcg |
| Vitamin B12 | 6 | mcg | 6 | mcg | 4.5-6 | 4.5-7.5 | mcg |
| Biotin | 300 | mcg | 300 | mcg | 225-300 | 225-375 | mcg |
| Choline (Al) | 550 | mg | 550 | mg | 413-550 | 413-687 | mg |
| | | | Nutrients | | | | |
| | Daily | | (approximate | | Nutrients | Nutrients | |
| Minerals | Value | | value) | | range I | range II | |
| Potassium | 3500 | mg | 3500 | mg | 2550-3500 | 2550-4375 | mg |
| Sodium | <2400 | mg | 1200 | | 900-1200 | 900-1500 | mg |
| Calcium | 1000 | mg | 1000 | mg | 750-1000 | 750-1250 | mg |
| Phosphorous | 1000 | mg | 1000 | mg | 750-1000 | 750-1250 | mg |
| Magnesium | 400 | mg | 400 | mg | 300-400 | 300-500 | mg |
| Iron | 18 | mg | 18 | mg | 13.5-18 | 13.5-22.5 | mg |
| Zinc | 15 | mg | 15 | mg | 11-15 | 11-19 | mg |
| Manganese | 2 | mg | 2 | mg | 1.5-2 | 1.5-2.5 | mg |
| Copper | 2 | mg | 2 | mg | 1.5-2 | 1.5-2.5 | mg |
| Chromium | 120 | mcg | 120 | mcg | 90-120 | 90-150 | mcg |
| Molybdenum | 75 | mcg | 75 | mcg | 56-75 | 56-94 | mcg |
| Selenium | 70 | mcg | 70 | mcg | 52-70 | 52-84 | mcg |
| Chloride | 3400 | mcg | 3400 | mcg | 2250-3400 | 2250-4250 | mcg |
| Iodine | 150 | mcg | 150 | mcg | 112-150 | 112-190 | mcg |

TABLE 6
Amino Acid content in 150 gm of invented food with range

| Essential | | Nutrients in mg | Nutrients |
|---|---|---|---|
| Amino | Daily value/kg | (approximate | range in |
| acids | body weight | value) | mg |
| Tryptophan | 4 mg | 723 | 542-900 |
| Threonine | 15 mg | 2102 | 1576-2627 |
| Isoleucine | 20 mg | 2368 | 1776-4800 |
| Lucien | 39 mg | 3840 | 2880-4800 |
| Lysine | 30 mg | 3065 | 2299-3831 |
| Methionine + | 15 mg | 719 | 539-899 |
| Cysteine | | 808 | 606-1010 |
| Phenylalanine + | 25 mg | 2544 | 1908-3180 |
| Tyrosine | | 1743 | 1307-2179 |
| Valine | 26 mg | 2512 | 1884-3140 |
| Hislidine | 10 mg | 1304 | 978-1630 |

Non-Essential Amino acids

| | Nutrients in mg | Nutrients |
|---|---|---|
| | (approximate | |
| | value) | range in mg |
| Arginine | 4033 | 3025-5041 |
| Alanine | 2027 | 1520-2534 |
| Aspartic acid | 6001 | 4500-7500 |
| Glutamic acid | 9687 | 7265-12100 |
| Glycine | 2454 | 1840-3067 |
| Proline | 2718 | 2038-3397 |
| Serine | 2779 | 2084-3474 |

This optimized nutrient powder is precooked by heat denaturation, is easy to prepare and saves time in the kitchen. Taste and texture of the food will depend on method of cooking and additional ingredients added according to the individual, cultural, demographic and ethnic preferences. Based on individual needs additional carbohydrate, protein or fat with omega 3, 6 ratio 1:1 is added to make it a balanced nutrition food of variable calories of up to and >4000 calories as desired. We can prepare shakes, porridge, soup, pancake, salad, gravy, chutney, chapatti, dosa, idly, appam, puttu and any other flour preparations of vegan, vegetarian or non-vegetarian nature. By adding cereals, roots, pulses and nuts with low omega 6 fatty acid we can make high calorie nutrient rich food with omega 3,6 ratio approximately 1:1 for those who are under weight, athletes, sports personal and body builders. By adding carbohydrate/starch, protein, sugar and fat with omega 3, 6 in the ratio 1:1 we can make delicacies like pudding, chocolate, spreads etc. of high nutrient value.

Method of preparing the optimized nutrient food according to various embodiments from different type of ingredients to meet specific requirement as part of taking care of the health and medical requirement are illustrated by way of the following examples. These optimized nutrition foods prepared by the following method provide about 650 calories in 150 g as per the nutritional analysis data.

### Example 1

Raw materials were selected considering the nutrient content of each item as per the laboratory analysis data of each item to obtain the nutritional composition of optimized nutrient food 90 gms of soybeans, 50 gms of Flax seed, and 10 gms of deoiled ground nut were individually cleaned and made free from foreign matter/impurities and followed by washing with water and air drying. Cleaned soybeans were heated gradually to a temperature about 150 degrees centigrade for about 30 minutes, cleaned flax seeds were heated gradually at a temperature about 100 degrees centigrade for about 20 minutes, deoiled ground nuts were heated gradually at a temperature about 120 degrees centigrade for about 20 minutes to obtain denatured and dehydrated products. The resultant denatured and dehydrated products individually was cooled to about 25 to 30 degrees centigrade; individually milled to obtain fine and coarse particle size below 200 microns, while maintaining a temperature of 30 to 40 degree centigrade. The milled powders so obtained was mixed with processed ready to use ingredients such as 2 gms of algae powder, 100 mg of L-methionine; vitamins and minerals are added so as to achieve the RDA value of vitamin A 5000 IU, vitamin C60 mg, vitamin D 400 IU, vitamin E 30 IU, vitamin K80 mcg, vitamin B1 1.5 mg, B2 1.7 mg, vitamin B3 20 mg, vitamin B5 10 mg, vitamin B6 2 mg, vitamin B9 400 mcg, vitamin B 126 mcg, biotin 300 mcg, choline 550 mg and minerals potassium 3500 mg, sodium 1200 mg, chloride 3400 mg, calcium 1000 mg, phosphorus 1000 mg, magnesium 400 mg, iron 18 mg, zinc 15 mg, manganese 2 mg, copper 2 mg, chromium 120 mcg, molybdenum 120 mcg, selenium 70 mcg, iodine 150 mcg as per calculation from nutritional data and lab analysis. The product so obtained above was packed immediately to minimize the exposure to oxygen and sun light and associated nutrient loss and stored in air tight, opaque containers in dark, cool place.

The resultant final product was found to have the following weight/weight % composition: protein with amino acids was about 33.5%; dietary fiber was at about 24%; omega 3 and 6 fatty acid were each about 8.5% and the ratio of omega 3 to omega 6 fatty acid was about 1:1; omega 9 fatty acid was about 6%; saturated fat was about 3%; starch/sugar was about 4.5%; a total of vitamins and minerals was about 8.3% and water was about 3.7%. The optimized nutritious food was found to be free from cholesterol and trans-fat.

This optimized nutrient food contains decosa hexanoic acid (DHA) a nutrient crucial for the developing nervous system of the fetus and children along with all other nutrients in optimal concentration for growth and development. This optimized food was administered in therapeutic dose among the children above 1 year of age as well as among the pregnant ladies and lactating mothers. It was found to be very effective for those who desired to have weight reduction, by sticking to this optimized food alone with enough water as per climatic conditions. Similarly this food was beneficial for those who were under weight and interested to gain weight while given with additional high calorie food.

### Example-2

Raw materials were selected considering the nutrient content of each item as per the laboratory analysis data of each item to obtain the nutritional composition of optimized nutrient food. 60 g goa beans, 60 g sacha inchi seeds, and 30 g deoiled water melon seed were individually cleaned and made free from foreign matter/impurities and followed by washing with water and air drying. Cleaned goa beans were heated gradually at a temperature about 150 degrees centigrade for about 30 minutes, cleaned sacha inchi seeds were heated gradually at a temperature about 120 degrees centigrade for about 20 minutes, cleaned deoiled water melon seeds were heated gradually at a temperature about 120 degrees centigrade for about 10 minutes to obtain denatured and dehydrated products. The resultant denatured and dehydrated products were individually cooled to about 25 to 30 degrees centigrade; individually milled to obtain fine and coarse particle size below 200 microns, while maintaining a temperature of 30 to 40 degree centigrade. The milled powders so obtained was mixed with processed ready to use ingredient viz. 150 mg of L-methionine; vitamins and minerals so as to achieve the RDA value of vitamin A 5000 IU, vitamin C60 mg, vitamin D 400 IU, vitamin E 30 IU, vitamin K80 mcg, vitamin B1—1.5 mg, B2—1.7 mg, vitamin B3—20 mg, vitamin B5—10 mg, vitamin B6—2 mg, vitamin B9—400 mcg, vitamin B 12—6 mcg, biotin—300 mcg, choline 550 mg and minerals potassium 3500 mg, sodium 1200 mg, chloride 3400 mg, calcium 1000 mg, phosphorus 1000 mg, magnesium 400 mg, iron 18 mg, zinc 15 mg, manganese 2 mg, copper 2 mg, chromium 120 mcg, molybdenum 120 mcg, selenium 70 mcg, iodine 150 mcg as per calculation from nutritional data and lab analysis. The resulting product was packed immediately to minimize the exposure to oxygen and sun light and associated nutrient loss and stored in air tight, opaque containers in dark, cool place.

The resultant final product was found to have the following weight/weight % composition: protein with amino acids was about 34%; dietary fiber was at about 24%; omega 3 fatty acid was about 9% and omega 6 fatty acid was about 8% and ratio of omega 3 to omega 6 fatty acid was about 1.1:1; omega 9 fatty acid was about 6%; saturated fat was about 3%; starch/sugar was about 4.2%; a total of vitamins and minerals was about 8.3% and water was about 3.5%. This optimized nutrition food was found to be free from cholesterol and trans-fat.

This optimized nutrient food had slightly high omega 3 content than the omega 6 and was beneficial in supplementing people with inflammatory diseases like arthritis, thyroiditis and asthma. After taking this optimized nutrient food for a month by those who are suffering from said disease, there was remarkable improvement in their health. It was also found to be very effective for those who desired to have weight reduction.

### Example-3

Raw materials were selected considering the nutrient content of each item as per the laboratory analysis data of each item to obtain the nutritional composition of optimized nutrient food. 80 g hemp seed, 40 g perilla seed, and 30 g deoiled soy beans were individually cleaned and made free from foreign matter or impurities and followed by washing with water and air drying. Cleaned hemp seeds were heated gradually at a temperature about 100 degrees centigrade for about 10 minutes, cleaned perilla seeds were heated gradually at a temperature about 100 degrees centigrade for about 10 minutes, cleaned deoiled soy beans were heated gradually at a temperature about 120 degrees centigrade for about 10 minutes to obtain denatured and dehydrated products. The resultant denatured and dehydrated products was cooled to about 25 to 30 degrees centigrade; individually milled to obtain fine and coarse particle size below 200 microns, while maintaining a temperature of 30 to 40 degree centigrade. The milled powders so obtained was mixed with processed ready to use ingredients viz. 3 gms of algae powder, 100 mg methionine, vitamins, minerals and amino acids so as to achieve the RDA value of vitamin A 5000 IU, vitamin C 60 mg, vitamin D 400 IU, vitamin E 30 IU, vitamin K 80 mcg, vitamin B1—1.5 mg, B2—1.7 mg, vitamin B3—20 mg, vitamin B5—10 mg, vitamin B6—2 mg, vitamin B9—400 mcg, vitamin B 12—6 mcg, biotin—300 mcg, choline 550 mg and minerals potassium 3500 mg, sodium 1200 mg, chloride 3400 mg, calcium 1000 mg, phosphorus 1000 mg, magnesium 400 mg, iron 18 mg, zinc 15 mg, manganese 2 mg, copper 2 mg, chromium 120 mcg, molybdenum 120 mcg, selenium 70 mcg, iodine 150 mcg as per calculation from nutritional data and lab analysis. d) The product so obtained above was packed immediately to minimize the exposure to oxygen and sun light and associated nutrient loss and stored in air tight, opaque containers in dark, cool place. The resultant final product was found to have the following composition in weight/weight %: protein with amino acids was about 35%; dietary fiber was at about 21.5%; omega 3 fatty acid 10% and omega 6 fatty acid were about 8% each and the ratio of omega 3 to omega 6 fatty acid was about 1.25:1; omega 9 fatty acid was about 5%; saturated fat was about 4%; starch/sugar was about 4.5%; the total of vitamins and minerals were about 8.4% and water was about 3.6%. The optimized nutritious food was free of cholesterol and trans-fat.

This optimized food had high content of omega 3 LA along with DHA, SDA (steriodonic acid) and omega 6 GLA (Gama linoleic acid); all having anti-inflammatory properties. This food was useful in supplementing people with inflammatory and immune disorders like atopic dermatitis, asthma, psoriasis, and rheumatoid arthritis.

### Example 4

Raw materials were selected considering the nutrient content of each item as per the laboratory analysis data of each item to obtain the nutritional composition of optimized nutrient food. 30 gms of walnut and 60 gms of chia seed were individually cleaned and made free from foreign matter/impurities and followed by washing with water and air drying. Cleaned walnuts were heated gradually at a temperature about 100 degrees centigrade for about 20 minutes, cleaned chia seeds were heated gradually at a temperature about 100 degrees centigrade for about 10 minutes to obtain denatured and dehydrated products. The resultant denatured and dehydrated products was cooled to about 25 to 30 degrees centigrade; individually milled to obtain fine and coarse particle size below 200 microns, while maintaining a temperature of 30 to 40 degree centigrade. The milled powders so obtained was mixed with processed ready to use ingredient viz way protein 45 g, fruit sugar 10 g, fructose oligosaccharide 5 g; vitamins and minerals are added so as to achieve the RDA value of vitamin A 5000 IU, vitamin C60 mg, vitamin D 400 IU, vitamin E 30 IU, vitamin K80 mcg, vitamin B1—1.5 mg, B2—1.7 mg, vitamin B3—20 mg, vitamin B5—10 mg, vitamin B6—2 mg, vitamin B9—400 mcg, vitamin B 12—6 mcg, biotin—300 mcg, choline 550 mg and minerals potassium 3500 mg, sodium 1200 mg, chloride 3400 mg, calcium 1000 mg, phosphorus 1000 mg, magnesium 400 mg, iron 18 mg, zinc 15 mg, manganese 2 mg, copper 2 mg, chromium 120 mcg, molybdenum 120 mcg, selenium 70 mcg, iodine 150 mcg as per calculation from nutritional data and lab analysis. The product so obtained above was packed immediately to minimize the exposure to oxygen and sun light and associated nutrient loss and stored in air tight, opaque containers in dark, cool place.

The resultant final product was found to have the following % composition by weight/weight %:protein with amino acids was about 33%; dietary fibre was about 17%; omega 3 and 6 fatty acid were about 8% each and the ratio of omega 3 to omega 6 fatty acid was 1:1; omega 9 fatty acid was about 6%; saturated fat was about 3%; starch/sugar was about 12%; vitamins and minerals was about 9.3% and water was about 3.7%. The optimized nutritious food is found to be free from cholesterol and trans-fat.

This optimized nutrient food was sweet and could be taken with cold water as chilled shake, making it an instant optimized nutrient drink. This contains low level of fruit sugar which will be used for the energy requirement of nerve tissue in subjects on low calorie diet. This was given to obese diabetic patient who required weight reduction. The chance of tiredness and hypoglycaemic episodes were less while on this supplement drink and weight reduction was easy by sticking to low calorie diet.

### Example 5

Raw materials were selected considering the nutrient content of each item as per the laboratory analysis data of each item to obtain the nutritional composition of optimized nutrient food. 80 gms of soybeans, 40 gms of Flax seed, 20 g garden cress seed and 10 gms of deoiled ground nut were selected individually cleaned and made free from foreign matter/impurities and followed by washing with water and air drying. Cleaned soy beans were heated gradually at a temperature about 150 degrees centigrade for about 30 minutes, flax seeds were heated gradually at a temperature about 100 degrees centigrade for about 10 minutes, cleaned deoiled ground nuts were heated gradually at a temperature about 120 degrees centigrade for about 10 minutes to obtain denatured and dehydrated products. The resultant denatured and dehydrated products were individually cooled to about 25 to 30 degrees centigrade; individually milled to obtain fine and coarse particle size below 200 microns, while maintaining a temperature of 30 to 40 degree centigrade. The milled powders so obtained was mixed with processed ready to use ingredient viz. 2 gms of algae powder, 100 mg of L-methionine; vitamins and minerals are added so as to achieve the RDA value of vitamin A 5000 IU, vitamin C60 mg, vitamin D 400 IU, vitamin E 30 IU, vitamin K80 mcg, vitamin B1—1.5 mg, B2—1.7 mg, vitamin B3—20 mg, vitamin B5—10 mg, vitamin B6—2 mg, vitamin B9—400 mcg, vitamin B 12—6 mcg, biotin—300 mcg, choline 550 mg and minerals potassium 3500 mg, sodium 1200 mg, chloride 3400 mg, calcium 1000 mg, phosphorus 1000 mg, magnesium 400 mg, iron 18 mg, zinc 15 mg, manganese 2 mg, copper 2 mg, chromium 120 mcg, molybdenum 120 mcg, selenium 70 mcg, iodine 150 mcg as per calculation from nutritional data and lab analysis. The product so obtained above was packed immediately to minimize the exposure to oxygen and sun light and associated nutrient loss and stored in air tight, opaque containers in dark, cool place.

The resultant final product was found to have the following % composition by weight/weight: about 32.5% of protein with complete amino acids; about 25% high dietary fiber; about 8.5% each of omega 3 and 6 fatty acid, and, a ratio of omega 3 to omega 6 fatty acid of about 1:1; about 6% of omega 9 fatty acid; about 3% of saturated fat; about 4.5% of starch/sugar; about 8.3% of vitamins and minerals and about 3.7% water. The optimized nutritious food was found to be free from cholesterol and trans-fat.

This optimized nutrient food was ideal for subjects with constipation and haemorrhoids as it contain around 25% fiber with water retention ability. It was also effective for those who desired to have weight reduction, by sticking to this optimized food

### Example-6

30 patients of age 20-40 yrs. with menstrual irregularity and overweight/obesity (BMI>25) were taken for study. The patients were divided into two groups. All patients were given standard modern medical treatment for correction of menstrual irregularities. All the patients were asked to reduce fat, starch and sugar in their diet and include more low calorie vegetables, fruits, pulses/fish/meat/egg/milk along with mild to moderate exercise. Second group was advised to take 100 gm of optimized nutrient food prepared by a process as given in Example-1 daily along with low calorie vegetables, fruits, and to avoid all other food as much as possible for a period of 120 days with mild to moderate exercise, here after called optimized nutrient food diet.

At the end of 60 days patient in both the groups were relieved of menstrual problems. In the first group weight was either maintained or an increase of about 0.5-3% was observed. In the second group there was a reduction of 6-12% of the original weight. The patients in first group were not able to restrict their carbohydrate intake due to tiredness. But the patients on optimized nutrient food diet were able to stick on to low calorie diet without difficulty.

At the end of 60 days the medication for regularization of periods was stopped. First group was advised to continue their regular diet and exercise and the second group was advised to continue with optimized nutrient food diet, in addition to mild to moderate exercise. At the end of 120 days first group who were not sticking to their low calorie diet, had a further gain of 0.5-2% of weight and menstruation became irregular again. The second group had a reduction in weight of further 4-8%, menstruation continued to be regular, and they were sticking to the low calorie diet without difficulty.

The regularization of periods in the optimized nutrient food diet group is due to the correction of hormonal imbalance as a result of optimization of nutrients and weight reduction. When essential nutrients are available body can use stored fat as an energy source. If the calorie intake is reduced to less than 1000 calorie, one can reduce almost 1 kg/week without much added exercise. Optimization of nutrients and reduction in calorie intake with optimized nutrient food, helps the second group of patients in weight reduction and correction of hormonal imbalance, thereby results in regularization of periods.

### Example-7

30 patients of age 25-40 yrs with diabetics and fertility problems planning for pregnancy were taken for study. The patients were divided into two groups. All patients were given metformin 500 mg twice daily and advice was given on diet. They were given other standard modern medical treatment for the fertility problems too. All the patients were asked to reduce fat, starch and sugar in their diet and to include lower calorie vegetables, fruits, pulses/fish/meat/egg/milk along with mild to moderate exercise. Second group was advised to take 100 gm of optimized nutrient food prepared by a process as given in Example-1 daily along with low calorie vegetables, fruits, and avoid all other food as much as possible and here after called optimized nutrient food diet for a period of 60 days.

At the end of 30 days both groups showed improvement in blood sugar (FBS&PPBS) values, but the second group who was on optimized nutrient food diet showed significantly better control on blood sugar (FBS/PPBS). At the end of 60 days there was improvement in blood sugar (FBS/PPBS) and HbA1C values for both the groups. But 80% of the first group had not attained sufficient control for trying for conception as per FBS (<110 mg %), PPBS (<140 mg %) and HbA1C (<6%). For better control of blood sugar they were in need to start on insulin. The patients in first group were not able to restrict their carbohydrate intake due to tiredness.

But those who were on optimized nutrient food diet showed significant improvement on FBS, PPBS and HbA1C. Overweight and obese diabetic patients showed marked improvement with optimized nutrient food diet and none of them required insulin before conception. Only one patient with normal weight (BMI<25) required insulin for control of blood sugar among optimized nutrient food diet group. The patients on optimized nutrient food diet had additional advantage other than better blood sugar control like weight reduction, better ovulation, improved conception rate, less miscarriages and pregnancy related complications like pregnancy induced hypertension and preterm labor. The patients on Optimized nutrient food diet were able to stick on to low calorie diet without difficulty.

Better control of blood sugar in optimized nutrient food diet group is due to correction of insulin resistance with the help of optimized nutrition especially chromium and omega 3 fatty acid along with weight reduction and reduced carbohydrate intake. Optimized nutrient food diet will help in better control of diabetes with lower dose of hypoglycemic medication, in type I diabetes. In obese type II diabetics optimized nutrient food diet can give cure for diabetes with weight reduction. In both these 2 examples patients were advised to take low calorie food, but those patients in the first group were not able to follow the low calorie diet because of the tiredness. But the second optimized nutrient food diet group patients were able to reduce calorie intake by reducing on cereals and fat because, from optimized nutrient food they were getting all the essential nutrients and body was able to use the stored fat for the energy needs; which resulted in sticking to diet without difficulty and resultant weight reduction.

### Example 8

20 patients of age 20-50 yrs complaining of underweight and tiredness with BMI less than 17.5 are taken for study. The patients were divided into two groups. All the patients had a physical checkup in addition to blood and urine checkup. Most of them were showing anemia and vitamin D3 deficiency which was treated according to the modern medical management. Both the groups was asked to take high calorie diet with more nuts, rice, wheat, butter, oil, fried food etc. Second group was given 100 gms Optimized nutrient food prepared by a process as given in Example-1 along with said high calorie food.

At the end of 30 days first group had weight gain of 2-5% only. But the second group had gained 10-15% of their original weight. At the end of 60 days all patients in the first and second group on blood checkup showed significant improvement in hemoglobin and vitamin D3 level. Further weight gain for patients in the first group was less than 5%. But patients in the second group showed additional weight gain of 5-15%. At the end of 90 days; patients in the first group attained normal hemoglobin level and improved vitamin D3 level. But there was no further significant weight gain. At the end of 90 days all patients in the second group had gained weight to normal BMI of 19-20 and asked to reduce the calorie intake from starch and fat to avoid over weight gain for those who had crossed BMI 20. In addition to weight gain and correction of anemia and vitamin D3 level, patients in the second group showed general improvement in health, appearance, confidence level, attractiveness, work efficiency and endurance.

Both groups were asked to take high calorie diet, but the weight was significantly higher in optimized nutrient food group. The reason for the increased weight gain for the second group patients was, they were taking all the essential nutrients in the correct proportion with high calorie diet. For the proper absorption and utilization of nutrients for body building, it is essential to have all nutrients in correct proportion.

### Example 9

30 Perimenopausal patients with hypertension, BP 130/90-160/100 mm of Hg were selected for study. Most of these patients were suffering from perimenopausal problems like mood swings, and hot flashes. On investigation most of the patients were showing high cholesterol and triglycerides and low vitamin D3 level. Patients were divided into two groups. First group patients were asked to follow their regular diet and increased sun light exposure, second group was advised to take 100 g of Optimized nutrient food prepared by a process as given in Example-5 and reduce on other food except vegetables and fruits.

At the end of 15 days all the patients in the first group were continuing as hypertensive. But all the patients in second group had substantial reduction in their blood pressure. At the end of 30 days for all the patients in the second group blood pressure had come down to <130/80 and were asked to reduce. Optimized nutrient food to 50 g daily. At the end of 60 days the BP come down to 120/80 in spite of reduction in Optimized nutrient food to 50 gm.

At the end of 60 days 30% patients in the first group had an increase in BP by 4-10 mm of mercury and they were in need for optimized nutrient food diet or anti-hypertensive medication. Even though the patients were asked to have more sun light exposure, there was no substantial increase in vitamin D3 level of the patients in first group, mainly because they were not able to get enough exposure considering their life style. The patients in optimized nutrient food diet group had additional benefits of improvement in lipid profile, improved vitamin D3 level, reduction in hot flashes, mood stabilization, weight reduction etc. Low sodium, high potassium, high omega 3 with omega 3,6, ratio 1:1 and optimization of all other nutrients in optimized nutrient food diet group had given all these health benefits to optimized nutrient food diet patients. Even with one third of the dose of nutrients, 50 g optimized nutrient food was enough to maintain the BP to normal with all other additional advantages which makes optimized nutrient food a wonder food.

### Example 10

20 patients with constipation and piles with bleeding (hemorrhoids) were taken for study. The patients were divided into 2 groups. All the patients were asked to take more vegetables and fruits and given standard modern medical treatment with laxative and ointment for local application for 10 days and asked to stop medication when the symptoms are relieved and asked to restart if recurrence occurs. Second group of patients were asked to take 100 gm of optimized nutrient food prepared by a process as given in Example-5 daily along with regular food.

At the end of 15 days, the optimized nutrient food group patients who had taken the medicine just for 3-4 days had relief from constipation and piles. The patients in the first group also had significant relief of symptoms but had to use the laxative and anal ointment almost fully. Both the groups were asked to continue diet with more vegetable and fruits and second group to continue with optimized nutrient food 100 g daily.

At the end of 30 days in the first group there was recurrence of constipation in 60% of patients and 20% had recurrence of piles and bleeding. In the second optimized nutrient food group, patients had regular stool and no recurrence of constipation or piles/bleeding. The high fiber content of 25% with water retention ability of optimized nutrient food gave bulk to stool and softening effect which improved bowel function and peristalsis and prevented constipation & piles. High fiber content of optimized nutrient food additionally acts as prebiotic and helps in growth of healthy intestinal microbes and reduces chance of colon cancer.

### Example 11

20 patients with allergic symptom, sneezing were taken for study. Patients were divided into two groups. All the patients were given standard modern medical treatment with anti-allergic medication for 10 days. The second group, additionally was advised to have 100 g optimized nutrient food prepared by a process as given in Example-1 daily and advised to avoid nuts and oils with high omega 6 content. At the end of 10 days it was noticed that both the groups of patients had substantial reduction in sneezing episodes. At the end of 10 days all patients were asked to stop anti allergic medication and second group were advised to continue optimized nutrient food and avoid high omega 6 food for another 20 days.

At the end of 30 days first group patients had recurrence of allergic symptoms and sneezing. But the second optimized nutrient food group did not have recurrence and had substantial relief of symptoms. High omega 3 fatty acid with optimized omega 3, 6 ratio and optimal minerals, vitamin and amino acids present in optimized nutrient food had helped to balance the inflammatory and immune system of the body, thereby giving relief from allergic symptoms.

### Example 12

20 patients with asthma and on salbutamol+steroid inhaler were taken for study. The patients were divided into two groups. Patients in second group were asked to take 100 g of optimized nutrient food prepared by a process as given in Example-1 daily with their regular food and were asked to avoid food with preservatives, coloring agents, artificial flavoring agents, nuts and oil with high omega 6 content.

At the end of 30 days patients in the optimized nutrient food group had substantial reduction in breathing difficulty and were able to reduce the dose of inhaler medication. But patients in first group without optimized nutrient food were continuing with the same dose of inhalation medication. Asthma is considered as an inflammatory disorder of the respiratory system. Here also high omega 3 content with optimal omega 3, 6 ratio and other essential nutrients of optimized nutrient food helped in balancing the inflammatory and anti-inflammatory response of the body and thereby giving beneficial effect in asthmatic patients.

### Example-13

Two pregnant women at 16-18 weeks gestation were diagnosed to have structural anomalies for the baby by ultra sound scan and fetal MRI. One is having hydrocephalus and the other is having scoliosis of the vertebrae. Both the patients were given 100 gms of optimized nutrient food prepared by a process as given in Example-1 with other standard antenatal care. Repeat ultra sound scan after 30 days and 60 days showed correction of structural anomaly for both the fetuses.

This is in line with the international research findings on the relevance of nutrition of the pregnant mother and development of structural anomalies to the fetus especially, the relationship of folic acid and choline on neural tube defect and omega 3 fatty acid on brain and retinal development of the baby and omega 3, and omega 6 in success of IVF cycles and prevention of preterm labor. No doubt that Amino acids and fatty acids are the major building block of the cells and other nutrients like vitamins, minerals & trace elements have structural & functional role in growth and development. Hence optimal nutrients present in optimized nutrient food’ with almost all the 55 nutrients (20 aminoacids+4 fatty acids+3 carbohydrates+14 vitamins+14 minerals) at optimal level required for the developing ova, sperm and fetus determines the health of the future baby which was responsible for the dramatic result narrated above.

Few of the relevant case studies shown in the examples given above and the results obtained fully justify our contention that the surprising findings are attributable to synergetic effect of the constituents involved in the state of the art optimized nutrient food according to the present invention. It is also in line with the nutritional analysis report of different food items commonly used for human consumption which forms the basis of the present disclosure.

More than 70% of the global population above 50 yrs of age are suffering from DRNCD (diet related non communicable diseases) like overweight, obesity, metabolic syndrome, diabetes, hypertension, heart diseases, cancer, arthritis etc. and are taking multiple drugs and undergoing major operations for relief.

A major part of individual's income and nation's income is spent to treat these diseases. Loss of productivity, illness and the side effects of the medication and surgery is adding to the sufferings. Prevention is better than cure. We can prevent not only communicable diseases but also DRNCD, the life style diseases, with optimized nutrition. Optimized nutrient food having about 650 calorie optimal nutrition food is the simple safe and economic answer to the prevention of the current epidemics of DRNCD. ‘Let food be your medicine, not medicine, your food’.

We have brought out the novel features of the invention by explaining some of the preferred embodiments under the invention, enabling those in the art to understand and visualize our invention. Numerous changes can be made without departing from the concept discussed herein. Hence it is to be understood that within the scope of the claims provided herein, the invention may be practiced otherwise then as specifically described herein.

We claim:

1. An optimized nutrient food for optimization of bodily functions and thereby maintenance of health, prevention of diseases and delaying aging, the optimized nutrient food comprising:
a) about 28% to about 36% of protein;
b) about 17% to about 26% of dietary fiber;
c) about 6% to about 10% of omega 3 fatty acid;
d) about 6% to about 10% of omega 6 fatty acid;
e) about 4% to about 8% of omega 9 fatty acid;
f) about 2% to about 6% of saturated fat;
g) about 4% to about 13% of low starch/sugar;
h) about 6% to about 10% of vitamins and minerals; and
i) about 2% to about 5%, by weight of water;
j) while maintaining a ratio of omega 3 fatty acid to omega 6 fatty acid ranging from about 0.75:1.25 to about 1.25:0.75.

2. The optimized nutrient food as claimed in claim 1, wherein a) further comprises a free essential amino acid.

3. The optimized nutrient food as claimed in claim 1, wherein the ratio of omega 3 fatty acid to omega 6 fatty acid is about 1:1.

4. The optimized nutrient food as claimed in claim 1, comprising:
a) about 33.5% of protein;
b) about 24% of dietary fiber;
c) about 8.5% of omega 3 fatty acids;
d) about 8.5% of omega 6 fatty acids;
e) about 6% of omega 9 fatty acid;
f) about 3% of low saturated fat;
g) about 4.5% of low starch/sugar;
h) about 8.3% of vitamins and minerals; and
i) about 3.7% of water, by weight;
while maintaining a ratio of 1:1 of omega 3 fatty acid to omega 6 fatty acid;

5. The optimized nutrient food as claimed in claim 1, wherein the optimized nutrient food is free of cholesterol, trans-fat, or preservatives.

6. The optimized nutrient food as claimed in claim 1, wherein 114 grams of the optimized nutrient food provides about 466 calories and 150 grams of the optimized nutrient food provides about 650 calories.

7. The optimized nutrient food as claimed in claim 1, wherein the optimized nutrient food comprises recommended daily allowance of nutrients selected from the group consisting of dietary fibre, carbohydrate, non-essential fat, essential fat, protein with complete amino acids, vitamins, macro minerals and trace elements.

8. The optimized nutrient food as claimed in claim 1, wherein a source for preparing the optimized nutrient food is selected from a natural source, except for vitamins, minerals and essential amino acids that are additionally included for optimization of the nutrients in the optimized nutrient food.

9. The optimized nutrient food of claim 1, wherein a source for the protein with complete amino acids is selected from the group of both seeds/deoiled seeds, nuts/deoiled nuts consisting of soya beans, goa beans, hemp seed, water melon seed, pumpkin seed, sesame seed, Bengal gram, green gram, pistachios, gingili seed, poppy seed, black gram, flax seed, ground nut, de-oiled ground nut, coconut, water melon seeds, and also milk protein, egg protein, animal protein, fish protein, protein from single cell organism, amino acid, and combinations thereof.

10. The optimized nutrient food as claimed in claim 1, wherein a source for the omega 3 fatty acids is selected from the group consisting of flax seed, perilla seed, algae/algal oil, garden cress seed, mustard seed, canola seed, chia seed, sacha inchi, hemp seed, walnut/oil, krill oil, squid oil, fish oil, clary sage seed/oil, and combinations thereof.

11. The optimized nutrient food as claimed in claim 1, wherein a source for the omega 6 fatty acids is selected from the group consisting of gingili seed, sunflower seed, safflower seed, watermelon seed, corn seed, almond, cashew nut, black current seed, poppy seed, rape seed, borage seed/oil, evening primrose seed/oil, palm oil, avocado oil, olive oil, and combinations thereof.

12. The optimized nutrient food as claimed in claim 1, wherein a source for the high dietary fiber is selected from the group consisting of oats bran, rice bran, fenugreek seed, soya beans, flax seed, garden cress seed, rice bran, chicory root, aniseed, sun root, perilla seed, safflower seed, inulin's, vegetable gums, fructose oligo saccharide, and combinations thereof.

13. The optimized nutrient food as claimed in claim 1, wherein optimization of vitamins and minerals are selected from Brazil nut for selenium; oats bran for chromium; gingili for zinc; garden cress and water melon seed for iron, artificial vitamins and minerals from appropriate salts, and combinations thereof.

14. The optimized nutrient food as claimed in claim 1, wherein additional carbohydrate is added, additional protein is added, additional fat comprising a 1:1 ratio of omega 3 to omega 6 is added, whereby a balanced nutrition food comprising 4000 calories or greater is obtained.

15. An optimized nutrient food as claimed in claim 1 is used for
a) the treatment/prevention of diseases selected from a group consisting of obesity, underweight, menstrual irregularity, reproductive problems, infertility, heart disease, hypertension, diabetes, metabolic syndrome, fatty liver, and liver diseases, constipation, piles, arthritis, allergies, inflammatory disorders, asthma and cancer;
b) providing balanced nourishment to subjects selected from the group consisting of a pregnant mother, a product of conception, a placenta, a fetus, a baby in utero, a breast fed baby and breast feeding mother;
c) providing balanced nourishment to children selected from a group of a weaning child, a growing child, and an adolescent child;
d) functioning as an apt DASH diet (Dietary Approaches to Stop Hypertension) as well as recommended diet for the renal stone patients in need of and
e) reducing the occurrence of renal stone.

16. An optimized nutrient food as claimed 1, wherein it is capable of
a) optimizing the health and performance of subjects selected from the group consisting of athletes and sports persons, defense personals, astronauts, mariners and persons working under restricted conditions;
b) optimizing the health of adults and delaying aging and also improving quality of life of mentally challenged subject and senior citizen; and
c) optimizing in recovery and health of a sick and recuperating patient by administering as food and tube feed.

17. A method of treating the subjects comprising administering the optimized nutrient food as claimed in claim 1, wherein the medical condition of the subjects are selected from a group comprising of obesity, underweight, menstrual irregularity, reproductive problems, infertility, heart disease, hypertension, diabetes, metabolic syndrome, fatty liver, and liver diseases, constipation, piles, arthritis, allergies, inflammatory disorders, asthma, and cancer.

18. An optimized nutrient food as claimed in claim 17, wherein therapeutic dosage to be administered to the subjects is 2 g per kg per day for adults maximum of 150 g and 2-5 g per kg per day for children maximum of 150 g per day.

19. A method of preparing the optimized nutrient food as claimed in claim 1, the method comprising:
a) selecting components from a group consisting of a seed, a de-oiled seed, a nut, a de-oiled nut, a root, a combination of more than one seed, and combinations thereof, to obtain more than one selected component;
b) individually measuring the requisite quantity of the selected component required for a batch and cleaning the selected components of step a);
c) individually heating the products of step b) at a temperature ranging from about 50 degrees centigrade to about 150 degrees centigrade for about 10 to about 60 minutes to obtain a denatured and dehydrated product;
d) cooling the denatured and dehydrated products of step c) individually or in combination at a temperature ranging from about 25 degrees centigrade to about 30 degrees centigrade;
e) milling the products of step d) individually or in combination at a temperature ranging from about 30 degrees centigrade to about 40 degrees centigrade to obtain a particle size ranging from about 50 microns to about 200 microns;
f) mixing required quantities of the resultant individually milled powders from step e);
g) adding deficient nutrients to the product of step f) to obtain the composition of claim 1, wherein the deficient nutrients is selected from a group consisting of vitamins, minerals, and combinations thereof; and,
h) packing the product of step g) in such a way has to minimize the oxygen and sun light exposure and associated nutrient loss in air expelled/nitrogen filled opaque air tight containers.

20. The method of preparing the optimized nutrient food as claimed in claim 19, wherein additional processed components from a group consisting of a protein source, an omega 3 source, an omega 6 source, a fiber source, a vitamin, a mineral, an amino acid and a combination are added at step f) for optimization of nutrients.

21. The method of preparing the optimized nutrient food as claimed in claim 19, wherein one or more component is selected in step a) from a group consisting of a protein source, an omega 3 source, an omega 6 source, a fiber source, a vitamin, and a mineral to obtain more than one selected component;

22. The method of preparing the optimized nutrient food as claimed in claim 19, wherein step f) further comprises mixing a free amino acid with the product of step e) selected from the group consisting of lysine, tryptophan, phenylalanine, tyrosine, methionine, cysteine, threonine, leucine, isoleucine, valine, arginine, histidine, and combinations thereof.

23. The method of preparing the optimized nutrient food as claimed in claim 19, wherein the seed or de-oiled seed is selected from the group consisting of soya beans, goa beans, water melon seeds, flax seed, perilla seed, hemp seed, sacha inchi seed, sun flower seed, safflower seed, almond, garden cress seed, oats, gingili seed, fenugreek, pumpkin seeds, pistachio, corn seed, rape seed, poppy seed, sesame seed, black gram, Bengal gram, green gram, and combinations thereof.

24. The method of preparing the optimized nutrient food as claimed in claim 19, wherein the nut or de-oiled nut is selected from the group consisting of walnut, ground nut, coconut, cashew nut, brazil nut, almond, hazel nut, and combinations thereof.

25. The method of preparing the optimized nutrient food as claimed in claim 19, wherein the root is selected from the group consisting of chicory root, sun root, ginger root, arrow root, tapioca, potato, sugar beet, and combinations thereof.

26. The method of preparing the optimized nutrient food as claimed in claim 19, wherein vitamins in step g) is selected from the group consisting of Vitamin A, Vitamin D, Vitamin E, Vitamin K, Vitamin C, B complex vitamins, biotin, choline, and combinations thereof.

27. The method of preparing the optimized nutrient food as claimed in claim 19, wherein the minerals in step g) comprise salt forms of minerals, wherein the minerals are selected from the group consisting potassium, chloride, calcium, phosphorus, sodium, magnesium, zinc, iron, manganese, copper, iodine, chromium, molybdenum, selenium, and combinations thereof.

28. The method of preparing the optimized nutrient food as claimed in claim 19, wherein additional components are added after step f), wherein the additional components are selected from the group consisting of vitamins, minerals, amino acid, algae, milk protein, whey protein, egg protein, fish protein, meat protein, algae oil, fish oil, krill oil, squid oil, evening primrose oil, black current seed oil, borage seed oil, clary sage oil, and combinations thereof.

29. A method of preparing the optimized nutrient food as claimed in claim 19, wherein the protein source, omega 3 source, omega 6 source and dietary fibre source are processed or unprocessed.

30. A method of preparing the optimized nutrient food as claimed in claim 29, wherein
a) said processed protein source is selected from the group consisting of milk protein, whey protein, egg protein, fish protein, meat protein, processed vegetable protein, protein from single cell organism oil and combinations thereof.
b) said processed omega 3 source is selected from flax seed oil, perilla oil, walnut oil, sacha inchi seed oil, hemp seed oil, chia seed oil, echium oil, kiwifruit seed oil, canola oil, algae, algae oil, fish oil, krill oil, squid oil, clary sage oil, soybean oil and combinations thereof.
c) said processed omega 6 source is selected from the group consisting of evening primrose oil, black current seed oil, borage seed oil, hemp seed oil, sun flower oil, safflower oil, corn oil, cotton seed oil, gingili oil, ground nut oil, rice bran oil, soybean oil and combinations thereof, and
d) said processed dietary fiber sources is selected from inulin, vegetable gums, and fructose oligosaccharide and combinations thereof.

31. A method of preparing the optimized nutrient food as claimed in claim 29, wherein
a) unprocessed protein source is a seed or de-oiled seed, and wherein the seed or de-oiled seed is selected from the group consisting of soya beans, goa beans, water melon seeds, flax seed, perilla seed, hemp seed, sacha inchi seed, sun flower seed, safflower seed, almond, garden cress seed, oats, gingili seed, fenugreek, pumpkin seeds, pistachio, corn seed, rape seed, poppy seed, sesame seed, black gram, Bengal gram, green gram, and combinations thereof.
b) said unprocessed omega 3 source is selected from the group consisting of flax seed, perilla seed, garden cress seed, mustard seed, canola seed, chia seed, sacha inchi, hemp seed, walnut, clary sage seed, and combinations thereof.
c) said unprocessed omega 6 source is selected from the group consisting of gingili seed, sunflower seed, safflower seed, watermelon seed, corn seed, almond, cashew nut, ground nut, pumpkin seed, hemp seed, black current seed, poppy seed, rape seed, borage seed, evening primrose, and combinations thereof.
d) said unprocessed dietary fiber sources is selected from oats bran, rice bran, fenugreek seed, soya beans, flax seed, garden cress seed, rice bran, chicory root, aniseed, sun root, perilla seed, safflower seed, sun root, chicory root, and combinations thereof.

32. A method of preparing an optimized nutrient food as claimed in claim 19, the method comprising:
i) selecting and measuring more than one component from a group comprising a processed protein source, a processed omega 3 source, a processed omega 6 source, a processed fiber source, an artificially produced vitamin, an artificially produced mineral, and an artificially produced amino acid;
ii) mixing the product of step i);
iii) packing the product of step ii) in such a way to minimize oxygen and sunlight exposure and associated nutrient loss, wherein the components of step i) are in quantities required to provide the optimized nutrient food, and wherein the optimized nutrient food comprises:
a) about 28% to about 36% of protein;
b) about 17% to about 26% of dietary fiber;
c) about 6% to about 10% of omega 3 fatty acid;
d) about 6% to about 10% of omega 6 fatty acid;
e) about 4% to about 8% of omega 9 fatty acid;
f) about 2% to about 6% of saturated fat;
g) about 4% to about 13% of starch/sugar;
h) about 6% to about 10% of vitamins and minerals; and
i) about 2% to about 5%, by weight of water;
while maintaining a ratio of omega 3 fatty acid to omega 6 fatty acid ranging from about 0.75:1.25 to about 1.25:0.75.

33. An optimized nutrient food as claimed in claim-1 to 16 and prepared by a method as claimed in claims 19 to 32.

34. A food preparation comprising the optimized nutrient food as claimed in claim-1 to 16.
